(19) United States
(12) Patent Application Publication
(10) Pub. No.: US 2026/0004327 A1
(43) Pub. Date: Jan. 1, 2026

(54) INTEGRATED METHODS AND SYSTEMS FOR OFFERING AND MANAGING ADVERTISING CONTENT AND CAMPAIGNS IN COMBINATION WITH DELIVERY MEDIA FOR CONSUMER PRODUCTS AND SERVICES

(71) Applicant: Packaged, LLC, Ridgewood, NJ (US)

(72) Inventors: Joseph W. Hornstein, Franklin Lakes, NJ (US); Graham H. Byra, Hoboken, NJ (US)

(21) Appl. No.: 18/881,033

(22) PCT Filed: Jul. 11, 2023
(86) PCT No.: PCT/US2023/027323

§ 371 Date: Jan. 3, 2025

Related U.S. Application Data
(60) Provisional application No. 63/388,534, filed on Jul. 12, 2022.

(51) Int. Cl. G06Q 30/0241; G06Q 30/0251

(52) U.S. Cl. CPC G06Q 30/0276; G06Q 30/0254

(57) ABSTRACT

Integrated methods and systems are provided for offering and managing targeted advertising content and campaigns. More particularly, an exchange platform and method of its use are provided for offering and managing the identification and purchase of advertising space or inventory by advertisers that is available on virtual or physical media which has already been purchased, designed and used by distributors. The exchange platform includes a supply side for capturing, receiving, and managing supply side information which is then reorganized, analyzed, and collated to facilitate research and analysis by advertisers to determine whether suitable advertising inventory is available for the advertiser's advertising content, as well as which distributors and their media are likely to reach or contact desired or preferred market segments and consumer populations for targeted advertising campaigns. Tracking and monitoring the reach and successful consumer engagement by media and advertising content thereon are also enabled by the exchange platform.

### CROSS-REFERENCE TO RELATED APPLICATIONS

The present application is a national phase of International Patent Application No. PCT/US2023/027323, filed Jul. 11, 2023, published as WO/2024/015325, and which claims the benefit of U.S. Provisional Application No. 63/388,534 filed on Jul. 12, 2022, the entire disclosures of which are hereby incorporated by reference herein.

### FIELD OF THE INVENTION

The invention relates to methods and systems for offering and managing advertising content and campaigns. More particularly, the methods and systems enable participants to identify, match, and combine advertising content with suitable delivery media based at least in part on the characteristics of one or more of the participants, consumers, products, and services, as well as to monitor and manage the targeted advertising content to understand and improve criteria for the success and effect of targeted advertising campaigns.

### BACKGROUND

Methods and systems have been developed and are known for collecting and collating consumer demographic information to design and provide advertising content for delivering, communicating, or presenting to consumers, including targeted advertising content for consumers of selected market segments. Preferred market segments and the characteristics of their consumers may, for example, be selected based on the types and intended uses of the consumer products and services described or otherwise presented in the advertising content.

Methods and systems are known for designing delivery media having features based on any of several factors and criteria. For example, features of delivery media may be determined based on the characteristics of the consumer products and services delivered by the delivery media, the identity of the distributor using the delivery media, the identity of the manufacturer or seller of the consumer products and services being delivered or presented to consumers, or some combination of these and other criteria.

Notwithstanding the foregoing methods and systems, there do not yet exist integrated methods and systems, whether internet assisted or not, for accomplishing sophisticated data collection and analysis in a manner which enables advertisers or an intermediate provider to match advertising content with consumer product and service delivery media and distributors based concurrent assessments of consumer demographics, characteristics of consumer products and services, and the identities and characteristics of distributors, manufacturers, and advertisers themselves.

Furthermore, existing methods and systems for identifying and designing targeted advertising opportunities tend to focus on virtual or digital advertising media and outlets. There does not yet exist a platform which marries advertising inventory and opportunities in connection with physical delivery media, such as packaging for shipping and delivery of consumer goods, with advertisers having advertising content and seeking such inventory and opportunities, particularly advertisers interested in researching and reaching preferred populations of consumers or market segments which are definable by demographic and other characteristics and attributes.

### SUMMARY OF THE INVENTION

The invention described and contemplated here relates to an integrated advertising exchange platform which provides effective designing, managing, monitoring, and assessment of effectiveness of advertising content, a targeted advertising campaign which includes advertising content, or both, wherein the advertising content is affixed to or associated with available advertising inventory which is on or associated with delivery media, the exchange platform being capable of identifying, selecting, and reporting suitable advertising inventory from among the available advertising inventory based at least in part on one or more demand side requirements, preferences, and limitations, the exchange platform comprising a client software application (CSA) which includes a supply side module and a demand side module, each of which are accessible by one or more participants using one or more computing devices, wherein:
the supply side module manages supply side information and includes:
an advertising and data management (ADM) module which includes:
a data management submodule for receiving, organizing, and collating supply side information,
a database submodule comprising one or more databases for receiving and storing organized and collated supply side information,
one or more analysis submodules for further organizing, analyzing, collating, and reporting the supply side information stored in the one or more databases, including at least creating and assigning a unique unified consumer identification code (UCIC) to each consumer for which consumer information is received, and creating one or more centralized databases each of which contains at least a portion of the supply side information,
the demand side module including:
a graphical user interface (GUI) module which is programmed to be capable of:
receiving and managing demand side information which includes the one or more demand side requirements, preferences, and limitations,
providing and managing an onboarding process by executing an onboarding module which controls access and exchange of information by demand side participants to and from the exchange platform system and the one or more central databases,
selecting and reporting suitable advertising inventory from the available advertising inventory by analyzing and collating at least a portion of the supply side information with at least a portion of the demand side information,
designing, or enabling a demand side participant to design, advertising content, targeted advertising campaigns, or both, by executing an advertising campaign design module, wherein advertising content is affixed to or associated with suitable advertising inventory of the delivery media,
receiving, producing, and managing advertising content information which includes characteristics and attributes of the advertising content, and targeted advertising campaign information which includes characteristics and attributes of the targeted advertising campaign, and
providing, designing, or enabling a participant to design, one or more triggers which are affixed to or associated with the delivery media and collect and transmit supply side information to the ADM module of the supply side module.

The delivery media may comprise physical delivery media, virtual delivery media, and combinations thereof. Physical delivery media includes, but is not limited to, one or more of: packaging, product and service brochures, instruction manuals and other literature, billboards, posters, magazines, books, pamphlets, flyers, and any other tangible media which delivers, describes, provides, or communicates, consumer goods and services and their features, use, and operation to consumers.

Each participant may be at least one type of person or entity selected from: advertisers, distributors, delivery media providers, and proprietor participants. In some embodiments, a participant may be two or more types of persons or entities selected from: distributors, advertisers, advertising buyers, advertising brokers, delivery media providers, and proprietor participants.

The supply side information may, without limitation, include one or more types of information selected from: available advertising inventory information, delivery media information, supply side participant information, consumer demographic information, consumer product information, consumer service information, supply side participant industry information. The demand side information may, without limitation, include one or more types of information selected from: demand side requirements, preferences, and limitations, demand side participant information, demand side participant industry information, preferred consumer information, and preferred market segment information.

The one or more demand side requirements, preferences, and limitations include, without limitation, information selected from one or more of the following types of information: supply side participant information, demand side participant information, consumer demographic information, preferred market segment information, available advertising inventory information, delivery media information, consumer product information, and consumer service information

Each of the one or more triggers includes, but is not limited to: a quick response (QR) code, a barcode, universal product code (UPC), a digital coupon, a near field communication (NFC) tag, a radio frequency identification (RFID) device, a custom branded vanity uniform resource locators (URL), an email addresses, a push notifications, a non-fungible tokens (NFT), augmented reality, or combinations thereof.

The invention described and contemplated here also relates to a method for monetizing physical packaging using the integrated advertising exchange platform described above, wherein the delivery media comprises one or more physical delivery media selected from: packaging, product and service brochures, instruction manuals and other literature, billboards, posters, magazines, books, pamphlets, flyers, and any other tangible media which delivers, describes, provides, or communicates, consumer goods and services and their features, use, and operation to consumers.

The invention described and contemplated here also relates to a method for designing, managing and monitoring targeted advertising campaigns, including using delivery media having available advertising inventory and affixing or associating advertising content to or with, respectively, suitable advertising inventory which is identified and selected based matching supply side information relating to the available advertising inventory with demand side requirements, preferences, and limitations relating at least in part to preferred consumer demographic information, the method comprising the steps of:
managing supply side information by receiving, organizing, and collating the supply side information, wherein the supply side information includes one or more of: consumer demographic information, consumer product information, consumer service information, and supply side participant industry information, and wherein the supply side information is received from one or more sources which include one or more supply side participants, one or more triggers affixed to or associated with delivery media having available advertising inventory and used in the targeted advertising campaign, one or more information analysis methods, and one or more third party databases;
storing the organized and collated supply side information in one or more databases;
further organizing, analyzing, collating, and reporting the supply side information stored in the one or more databases, which includes creating and assigning a unique unified consumer identification code (UCIC) to each consumer for which consumer information is received, and creating one or more centralized databases each of which contains at least a portion of the supply side information, including the unique UCIC codes assigned to each consumer;
managing demand side information by receiving, organizing, and collating the demand side information, wherein the demand side information includes one or more of: one or more demand side requirements, preferences, and limitations, demand side participant information, demand side participant industry information, preferred consumer information, and preferred market segment information, and wherein the demand side information is received from one or more sources which include one or more demand side participants, and one or more information analysis methods;
identifying, selecting, and reporting suitable advertising inventory from the available advertising inventory by analyzing and collating at least a portion of the supply side information with at least a portion of the demand side information which comprises one or more demand side requirements, preferences, and limitations;
designing, or enabling a demand side participant to design, advertising content, targeted advertising campaigns, or both, by executing an advertising campaign design module, wherein advertising content is affixed to or associated with suitable advertising inventory of the delivery media,
receiving, producing, and managing advertising content information which includes characteristics and attributes of the advertising content, and targeted advertising campaign information which includes characteristics and attributes of the targeted advertising campaign, and
providing, designing, or enabling a participant to design, the one or more triggers which are affixed to or associated with the delivery media, wherein each trigger is capable of collecting and providing supply side information.

### BRIEF DESCRIPTION OF THE FIGURES

The present invention will be further explained with reference to the attached drawings, wherein like structures are referred to by like numerals and/or letters throughout the several views. The drawings shown are not necessarily to scale, with emphasis instead generally being placed upon illustrating the principles of the present invention.

FIG. 1 is a schematic representation of an exemplary embodiment of an ad exchange system for offering and managing targeted advertising content and targeted advertising campaigns, with sources of input and output and exemplary participants who interact with the ad exchange system also being shown;

FIGS. 2 and 3 provide examples of delivery media packaging which include bags and boxes with available space for targeted advertising content and optional triggers for collecting and transmitting information to the ad exchange system;

FIG. 4 is a schematic representation of a typical process whereby the Advertising and Data Management (ADM) module of the ad exchange system of FIG. 1 receives, organizes, and stores information from advertising distributors and their delivery media to identify and report space, on or otherwise associated, with delivery media that is available for purchase by advertisers (inventory), as well as to collect and collate various types of information (attributes) associated with consumers;

FIG. 5 is a schematic representation of the ADM program module of the ad exchange system shown in FIG. 1, which includes a data management submodule for receiving, organizing, and collating information, a database submodule for receiving and storing the organized and collated information, and several analysis submodules for further organizing, analyzing, collating, and reporting the information stored in the database;

FIG. 6 is a schematic representation of the data management submodule of the ADM program module shown in FIG. 5, providing more detail concerning how information is received, organized, collated, and stored in the database;

FIG. 7 is a schematic representation of how various types of information (attributes) relating to consumers are mapped or graphed by an executable module of the ADM;

FIG. 8 is a is a more detailed schematic representation of a typical consumer, i.e., such as one of those depicted in FIG. 7, as well as several examples of types of consumer attribute information that may be collected or received and associated with that customer, as well as examples of types of delivery media which may be a source of such consumer attribute information;

FIG. 9 is a schematic representation of the onboarding submodule of the Graphical User Interface (GUI) module first shown in FIG. 1, which manages access by advertisers to the ad exchange system for setting up new advertiser accounts or accessing existing accounts on the ad exchange system;

FIG. 10 is a schematic representation of additional submodules of the GUI module first shown in FIG. 1, including an advertising campaign design submodule and its several functional submodules, which enable an advertiser to design an advertising campaign based on parameters selected by the advertiser, and a report submodule which enables an advertiser to produce any of several types of reports, also based on parameters selected by the advertiser;

FIG. 11 is a schematic representation of the unit selection submodule of the advertising campaign design submodule shown in FIG. 10, which allows and manages the selection of parameters and characteristics for the delivery media (unit) and advertising inventory preferred by an advertiser; the unit selection submodule may also communicate with the ADM module to enable performing comparison and matching between parameters selected by an advertiser and advertising inventory on delivery media available for purchase and use by an advertiser to determine whether any qualifying packaging units exist which include advertising inventory having the aforesaid required or desired specifications provided by the advertiser (A);

FIG. 12 is a schematic representation of the creative selection submodule of the advertising campaign design submodule shown in FIG. 10, which allows and manages the selection of parameters by an advertiser for the design of the advertising content and graphics, and performs analysis, development, and production of technical specifications required to manufacture and produce delivery media having the desired advertising content and graphics thereon or otherwise associated therewith;

FIG. 13 is a schematic representation of the shipping selection function of the advertising campaign design submodule shown in FIG. 10, which allows and manages the selection of parameters by an advertiser for shipping the delivery media (units) having targeted advertising content thereon or otherwise associated therewith, and which integrates the selections and technical specifications from the creative from the creative selection function of FIG. 12; and

FIG. 14 is a schematic representation of the trigger selection function of the advertising campaign design submodule shown in FIG. 10, which allows and manages the selection by an advertiser of desired type and content of one or more triggers to be included with the advertising content for collecting and transmitting information relating to consumers, products, and delivery media back to the ad exchange system.

### DETAILED DESCRIPTION

Generally, the invention described and contemplated herein provides integrated methods and systems for offering and managing targeted advertising content and campaigns. It should be noted that, in the context of the system and method described and contemplated herein, “offering and managing” advertising means any one or more activities including, without limitation, developing, designing, offering, providing, proposing, selecting, implementing, publishing, delivering, monitoring, designing, and otherwise managing advertising content and campaigns, such as targeted advertising content and targeted advertising campaigns.

These methods and systems provide a platform, or “exchange,” which participants use to develop and implement targeted advertising, at least in part, by enabling participants with advertising content to identify and connect with other participants having delivery media which includes unused space or capacity (also referred to herein as “advertising inventory” or simply “inventory”) which is available and may by suitable for adding, containing, or otherwise combining the advertising content. Among other things, the methods and systems described and contemplated herein accomplish the monetization of physical packaging. More specifically, they provide and manage a virtual marketplace which connects advertisers to distributors of packaging (physical advertising delivery media) and produces a symbiotic relationship whereas advertisers gain access to consumers, including preferred consumer segments, and distributors are provided with a discount to the cost of their packaging. In some cases, distributors may even receive packaging for use with their products and services from providers or advertising brokers without charge, depending on the revenue received from one or more advertisers using advertising inventory on that packaging.

Uniquely, the methods and systems described and contemplated herein provide an advertising media buying platform which bridges a previously unaddressed gap between online and offline (e.g., physical media) advertising by providing sophisticated market research targeting and reporting capabilities of digital systems and methods with offline (e.g., physical media) advertising opportunities and strategies. Additionally, among other things, it is contemplated that access to and use of the advertising inventory exchange platform described herein may be managed and restricted according to a subscription system, which could potentially provide an additional revenue stream for participants who access and use the platform, such as without limitation, delivery media providers (e.g., packaging manufacturers, designers, and distributors), as well as distributors and advertisers.

Using advanced digital and internet-based data collection, warehousing, analysis and reporting techniques, the suitability of the unused space or capacity of delivery media, including virtual media, physical media, or both, for adding the advertising content is determined by these methods and systems based, at least in part, on the characteristics of one or more of the participants, consumers, products, and services, which are assessed concurrently by the platform. These methods and systems also enable participants to monitor and manage the targeted advertising content to understand and improve intended range of distribution, consumer influence, consumer satisfaction, cost efficiency, participant satisfaction, and other criteria for the success and effect of targeted advertising campaigns of advertising success and effect.

Unless expressly indicated otherwise herein, the terms “a” and “an” mean “at least one” or “one or more” of a feature, element, function, or component and should not be interpreted as being limited to a single feature, element, function, or component. For example, “a” user should not be interpreted to necessarily mean only one user, but rather at least one user, or one or more users.

Unless expressly indicated otherwise herein, the terms “for example” and “exemplary” are intended to mean that the elements and features being described or listed are not limited to the specific descriptions and lists provided. Even where the phrases “without limitation” or “not limited to” are not expressly stated, the specific elements and features described and listed as examples thereof should not be construed as an exhaustive or otherwise limiting description or list of such elements and features suitable for inclusion or use in connection with the presently described methods and systems.

As used herein, the terms “participants” and “users” are used interchangeably to describe persons or entities that access, use, and participate in at least a portion of the methods and systems described and contemplated herein for developing, implementing, monitoring, and managing targeted advertising and targeted advertising campaigns using space available on or otherwise associated with delivery media of other participants. Generally and without intending to be limited, “participants” and “users” include at least the following categories or types of persons and entities: advertisers, distributors, delivery media providers, and proprietor participants.

As used herein, the term “delivery media” means any media, physical, virtual, or other, which is capable of carrying, bearing, presenting, contacting, delivering, communicating, etc. advertising content to one or more consumers. Examples of physical delivery media include, but are not limited to, packaging, product and service brochures, instruction manuals and other literature, billboards, posters, magazines, books, pamphlets, flyers, and any other tangible media which delivers, describes, provides, or communicates, consumer goods and services and their features, use, and operation to consumers and users. Packaging, as used herein, includes without limitation flexible and rigid materials and containers (e.g., boxes, bottles, vessels, cartons, barrels, envelopes, bags, pouches, trays, etc.) formed from such materials. Examples of virtual delivery media include, but are not limited to, internet websites and webpages, electronic billboards, audio broadcasts (e.g., radio), and any other visual, auditory, electromagnetic media which delivers, describes, provides, or communicates, consumer goods and services and their features, use, and operation to consumers and users.

The terms “advertising inventory” and “inventory” are used interchangeably herein and mean any unused, blank, empty, or otherwise available, space or capacity on, in, or otherwise associated with delivery media of any kind that is available and may by suitable for adding, containing, or otherwise combining the advertising content. Suitability of inventory is generally determined by a participant (e.g., an advertiser, an advertising buyer, brand owner, etc.) having or offering to others who have advertising content for which it is desired to identify delivery media useful and likely to deliver the advertising content to consumers and others. The methods and systems described and contemplated herein facilitate and enhance the identification and matching of such inventory with compatible participants. In general, suitability is determined based, at least in part, on the characteristics of one or more of the participants, consumers, products and services, which are assessed concurrently by the platform.

“Delivery media providers” include, for example without limitation, print media providers and sellers (e.g., designers, writers, and printers of magazines, instruction sheets and manuals, product brochures and pamphlets, etc.), packaging providers and sellers (e.g., designers, manufacturers, and sellers of packaging of any type), internet content developers, hosts, and sellers (e.g., designers and programmers of internet content such as websites, webpages, and components and modules thereof, and any persons or entities who provide host servers and services for websites, webpages, and other internet content). Delivery media providers may also be intermediaries or brokers of available advertising space or capacity on or in delivery media, in between advertisers and distributors.

“Advertisers” include, for example without limitation, advertising buyers, advertising sellers, advertising designers, advertising producers, consumer product manufacturers, consumer service providers, consumer product and service sellers, brand name owners or licensees, and any others having an interest in advertising consumer products and services, brand names associated therewith, or both, on delivery media. For purposes of the methods and systems described herein, advertisers typically desire and seek to purchase or lease, in whole or in part, advertising media and space on advertising media which is suitable and available for adding or combining their advertising content thereon, therein, or otherwise therewith.

“Distributors” include, for example without limitation, consumer product manufacturers, consumer service providers, wholesale sellers, wholesale shippers, retail sellers, retail shippers, and others performing or having an interest in transporting, delivering, or otherwise providing consumer products and services in, on or otherwise using delivery media. Distributors often, but may or may not, have their own advertising content, or advertising content of their suppliers, on, in, or otherwise associated with delivery media they purchase and use.

For purposes of the methods and systems described herein, distributors typically use delivery media of some sort for their own use and that delivery media may have inventory (i.e., unused space or capacity), on, in, or with which advertising content may be combined (i.e., added, applied, printed, inserted, tied, tethered, or otherwise combined or associated therewith). Sometimes such distributors purchase or lease the delivery media and may be interested and willing to sell or lease such unused space or capacity on or in its delivery media to advertisers. From the point of view of delivery media providers, distributors may be considered “advertising partners” because distributors sometimes purchase delivery media, as well as design services and supplies for the delivery media, from delivery media providers. In this context, delivery media providers may or may not assist with or provide design services and supplies for producing the delivery media according to selections, preferences, and specifications provided by such distributors or “advertising partners.” On the other hand, it is contemplated that a distributor having need of or willing to use delivery media which includes advertising content of others may be provided or supplied with such delivery media free of charge by advertisers, advertising brokers, providers, or even other distributors.

As used herein, the terms “consumer” and “consumers” include, without limitation, customers, shoppers, buyers, recipients, and any other persons or entities that seek out, search for, purchase, receive, use, or otherwise interact with goods and services and delivery media which contains, is combined with or otherwise associated with the goods and services. Customers may also have had, or may potentially have, visual or physical contact with, interaction with, receipt of, possession of, etc., advertising content, advertising media, or both, which is on, in, combined or otherwise associated with delivery media.

The term “trigger” as used herein means any codes, transmission or other technology which can be programmed or designed to transmit or communicate consumer information and, optionally also contain and provide a URL or website address which may provide further product or service information. The type of trigger is not particularly limited, as long as it can be affixed or otherwise associated and transported with delivery media. Types of triggers include, for example without limitation, quick response (QR) codes, barcodes, universal product codes (UPCs), digital coupons, near field communication (NFC) tags, radio frequency identification (RFID) devices, custom branded vanity uniform resource locators (URLs), email addresses, push notifications, non-fungible tokens (NFTs), and augmented reality.

As used herein, “market segment” means a portion of a population of consumers, the members of which share the same, or have related or overlapping, characteristics, such as one or more demographic characteristics (e.g., age, gender, location, job, political or religious affiliation, etc.), personal interests, favorite hobbies, activities, or sports, among many other possible characteristics. One or more characteristics of interest are selected to define a market segment based on who is interested and why. Preferred market segments and the characteristics of their consumers may, for example, be selected based on the types and intended uses of the consumer products and services described or otherwise presented in the advertising content.

For example, a family restaurant chain seeking to identify a location for a new restaurant may define a market segment by income, age, marital status, number of children, etc. An athletic shoe manufacturer and brand that is interested in identifying new regions in which to advertise and sell their products may study their current and past customers to identify common characteristics and then use those to identify the market segment of interest in new regions where they do not yet advertise. These are extremely oversimplified, but illustrative, examples of who might be interested in identifying a market segment and why. The methods and systems described and contemplated herein employ analogous processes, analysis, and planning, but enable much more complicated and sophisticated methods for identifying and contacting market segments of interest, and then monitoring and assessing the success of the resulting targeted advertising campaigns.

It should be understood that, although one or more preferred embodiments of the integrated methods and systems are described as involving packaging providers offering a platform which enables advertisers having advertising content targeted for a selected market segment to identify available and suitable unused space or capacity on or in packaging used by distributors for delivering consumer products, the methods and systems are not limited to such embodiments. Rather, as will be recognized and understood by persons of ordinary skill in the relevant art, many additional different embodiments are contemplated and intended to be within the scope of the methods and systems described and contemplated herein for offering and managing advertising content and advertising campaigns. For instance, the utility and benefits of the methods and systems described and contemplated herein are not limited to targeted advertising, but may also, in fact, be successfully and beneficially applied to general advertising, such as that which is not necessarily targeted or focused on any particular market segment of customers or products and services.

For example, anyone may provide and allow access to a platform which embodies the methods and systems described and contemplated herein for offering and managing targeted advertising. Furthermore, any participant may use the platform to identify delivery media of any kind having unused space or capacity suitable for adding particular advertising content based, for instance, on the consumer products and services being delivered with the delivery media, or based on the demographics of the consumers receiving the delivery media. Similarly, any participant may use the platform to identify distributors using delivery media of any kind having unused space or capacity suitable for adding particular advertising content, based on selected characteristics of the distributors themselves. Conversely, a distributor or may use the platform to identify advertisers based on characteristics of the advertiser or characteristics of the consumer products and services described by that advertiser's advertising content. All of these and other embodiments are included within the scope of the methods and systems described and contemplated herein.

The integrated methods and systems provide advertisers, as well as other advertising participants (e.g., advertising campaign developers. advertising content designers, delivery media producers, advertising brokers, etc.) with a platform for identifying potential advertising delivery media, physical or virtual, which would be suitable for their targeted advertising content. Suitable advertising media would be, for example, media likely to be presented to or in contact with, and thereby potentially influence, a selected market segment of consumers with preferred demographics based on the consumer products and services described by the advertising content. In many circumstances, delivery media which is already being used to deliver consumer products and services by distributors (e.g., manufacturers, sellers, brokers, wholesale or retail distributors, etc.) would also be suitable for use as advertising media.

The methods and systems described herein also create opportunities for distributors to develop revenue streams by selling or leasing advertising inventory of their own delivery media, which they will or have already purchased and use to deliver consumer products and services to their own consumers.

The methods and systems described and contemplated herein involve performing comprehensive and concurrent assessments and selections based on several considerations and criteria, which will be described in detail hereinafter, to accomplish multiple goals including, but not limited to: (1) enhance and improve the effectiveness of the targeted advertising content in reaching and influencing the intended market segment and its consumers, (2) minimize conflict or enhance cross-appeal between the consumer products and services being delivered with the delivery media and those being described in the advertising content, and (3) minimize conflict or enhance cross-appeal between the sources (e.g., manufacturer, seller, distributor, advertiser, etc.) of the consumer products and services being delivered and those being described in the advertising content.

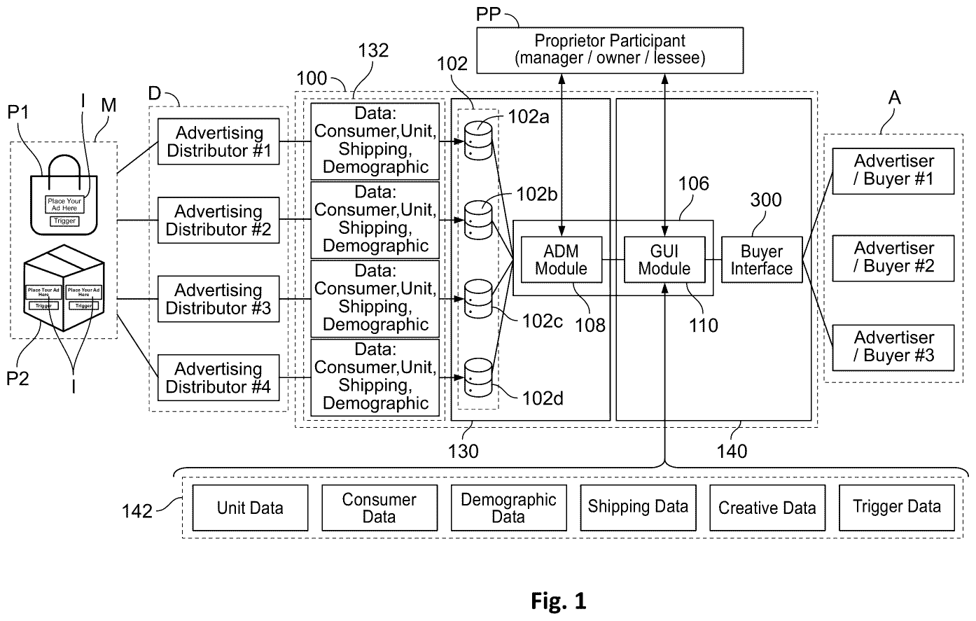

An exemplary embodiment of a system for offering advertising inventory on delivery media and for designing and managing advertising content and targeted advertising campaigns will now be described with reference to the figures. More particularly, FIG. 1 provides an overall schematic diagram of a system 100, hereinafter referred to as an “ad exchange system” 100, as well as external elements which interact with or are otherwise relevant to the ad exchange system 100 and its operation.

For example, the ad exchange system 100 may be accessed and used by participants, such as distributors (D), delivery media providers (not shown per se), and advertisers (A), to receive, store, analyze, and report information concerning advertising inventory (I) on delivery media (M), such as physical packaging (bags P1 and boxes P2) shown in FIG. 1, as well as many other types of information as discussed below. Based on and guided by instructions, parameters, selections, and requests provided by any participant, the ad exchange system 100 is capable of, for example without limitation, receiving, storing, identifying, analyzing, matching, organizing, managing, and reporting (collectively referred to as “managing”), all sorts of information provided by and received from participants, and sometimes from triggers and other scanning and transmitting technologies on or otherwise associated with packaging P1, P2.

More particularly, information (or “data”) managed by the ad exchange system 100 may, for example without limitation, relate to or describe distributors, their delivery media (M), advertising inventory (I) of their delivery media P1, P2, and their consumers. Additionally, information managed by the ad exchange system 100 may also, for example without limitation, relate to or describe advertisers (A) and their advertising content, as well as an advertiser's (A) selections for delivery media, consumers, market segments, advertising size and volume requirements and preferences. The ad exchange system 100 may also manage information provided by or otherwise received from delivery media providers including, for example without limitation, available delivery media options and specifications, quantities and manufacturing and shipping schedule options for delivery media, available graphics and other content for designing advertising content to be combined with delivery media, and pricing options for delivery media.

Additionally, proprietor participants (PP) who own, operate, maintain, manage, lease, or some combination thereof, the ad exchange system 100 may also access and engage with the ad-exchange system in any of the ways that other participants interact with the ad exchange system 100. For example, proprietor participants may include both an owner/lessor participant and a lessee participant for a particular ad exchange system 100. As another example, proprietor participants (PP) for a particular ad exchange system 100 may include both an owner participant, and a manager participant which is different from the owner participant. It is contemplated that such proprietor participants (PP) will likely have greater access and less security barriers than most other participants. For example, advertising media providers (e.g., designers, manufacturers, distributors, sellers, etc. of delivery media, whether virtual or physical) may be proprietor participants (PP) who fill the role of middleman between distributors and advertisers with respect to the design of delivery media and the sale and management of advertising inventory.

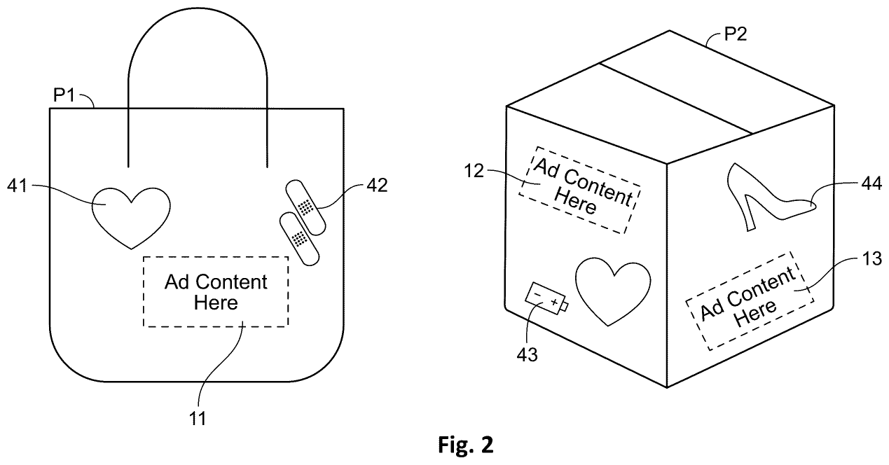

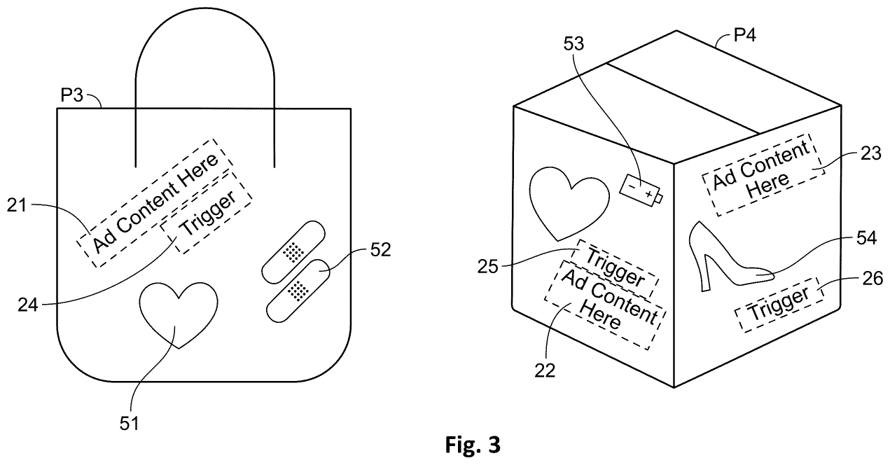

Referring now to FIGS. 2 and 3, exemplary delivery media having advertising inventory 11, 12, 13, 21, 22, 23 and preexisting advertising content or other graphics 41, 42, 43, 44, 51, 52, 53, 54 will be briefly described. Advertising media may be physical media including one or more types of packaging units, such as the bags P1, P3 and boxes P2, P4 shown in FIGS. 2 and 3. Each bag P1, P3 will typically include at least one advertising inventory space 11 and 12, 13, respectively, among preexisting (or already planned) advertising content 41, 42, 51, 52. Similarly, each box P2, P4 will typically include at least one advertising inventory space 21 and 22, 23, respectively, among preexisting (or already planned) advertising content 43, 44, 53, 54.

Furthermore, each advertising inventory space 11, 12, 13, 21, 22, 23 which is available on the bags P1, P3 and boxes P2, P4 may have different dimensions and be positioned in different locations on its respective bag P1, P3 or box P2, P4. Such dimension and location characteristics are among the kinds of supply side information 132 that is provided to the ADM module 108 and stored in at least one database 102, 102a, 102b, 102c, 102d, of the ad exchange system 100.

It is noted that, as shown in FIG. 3, delivery media such as a bag P3 or a box P4 may also include advertising inventory spaces 24 or 25, 26, respectively, which are suitable for affixing one or more triggers (not shown per se). It should be noted that advertising inventory I, 11, 12, 13, 21, 22, 23 may be used to add or affix advertising content, one or more triggers, or some combination thereof to packaging units, or any other delivery media. Regardless of whether a trigger is adjacent to advertising content or not, any trigger may or may not be related to, or otherwise associated with, any advertising content, regardless of whether both are affixed on or in the same packaging unit.

As described above, a trigger may be a source of supply side information 132 provided to the ad exchange system 100 (i.e., to the ADM module 108 of the CSA 106) for integration and storage in the one or more databases 102, 102a, 102b, 102c, 102d. More particularly, when delivery media, such as a bag P1, P3 or box P2, P4, having one or more triggers (not shown per se) thereon or therein is delivered to a consumer, such triggers will collect and transmit information relating to the consumer to the ad exchange system 100. Depending on the type of trigger, the consumer may have to scan, or otherwise read or decode, the trigger for the information to be collected and transmitted to the ad exchange 100. In some cases, a trigger may collect and transmit information without being purposely scanned or decoded by the consumer.

Additionally, not only may triggers be affixed to packaging by distributors (D) and provide consumer information to the ad exchange system 100, but triggers may be affixed or otherwise associated with advertising content of advertisers on packaging so that consumer information is collected and provided to the ad exchange system 100 for monitoring and analysis by the advertisers to determine the reach and success of the advertising content. In fact, it is contemplated that any one or more triggers may be affixed to delivery media (such as packaging) and programmed for the benefit of distributors (D), advertisers (A), another participant, or some combination thereof. As will be discussed in further detail later, triggers will typically not only collect and provide consumer information to the ad exchange system 100, but also deliver or provide additional information, interaction, or other experiences to consumers who receive or are otherwise in contact with the delivery media.

Consumer information which may be collected and transmitted to the ad exchange system 100 by a trigger includes, for example without limitation, one or more of: demographic consumer data including, without limitation, name, gender, age, marital status, family data (e.g., siblings, children, etc.), geographic location or region, residential address, occupation, income, level of education, hobbies or interests, political affiliation, religion, income; product and service purchase history; brand purchase history; type and age of vehicle owned; health status; medical history; and any other information which may assist in the evaluation or prediction of shopping and spending habits, interests, or tendencies. The ad exchange system 100 includes one or more security features and programming to protect and prevent unauthorized access to its databases 102a, 102b, 102c, 102d, etc., and consumer demographic data received and stored therein which qualifies as personally identifiable information (PII). Generally, PII means and includes information which can be used, either on its own or in combination with other information, to identify, contact, or locate a single person, or to identify an individual in context.

Returning to FIG. 1, the ad exchange system 100 includes a database 102 and a client software application (CSA) 106 which is in communication with the database 102 and with participants. The ad exchange system 100 and its database 102 and CSA 106 may be web-based and accessible by participants over the internet, such as through one or more user computing devices (not shown in the drawings).

Of course, it should be understood that a plurality of user computing devices (not shown), which may be the same or different from one another, may be used by one or more participants at any time. The user computing device may be any of several devices which is capable of accessing the Internet and communicating with the CSA 106 remotely. Such user computing devices generally have a display (e.g., a screen which may be touch activated or not) and an input/output component (e.g., a physical or virtual keyboard, a microphone, etc.). Each user computing device may, independently of others, be or include, for example without limitation, a personal computer, a smart phone, a cell phone, a personal digital assistant (PDA), a laptop, a tablet, and the like.

The database 102 may include a plurality of databases 102a, 102b, 102c, 102d, as shown in FIG. 1. Each database 102a, 102b, 102c, 102d is independently capable of receiving, storing, searching, and otherwise managing all sorts of information such as has been described above. The database 102 may reside, or be otherwise stored or saved, on one or more physical servers or networks, in cloud storage, or a combination thereof. Where the database 102 comprises a plurality of databases 102a, 102b, 102c, 102d, each of the plurality of databases 102a, 102b, 102c, 102d may reside or be otherwise stored or saved in the foregoing manner, either together, or separately and independently from one another.

As shown in FIG. 1, the CSA 106 comprises an advertising and data management (ADM) module 108 which generally manages access, communication, and information on the “supply side” 130 of the ad exchange system 100. The CSA 106 also comprises a graphical user interface (GUI) module 110 which generally manages access, communication, and information on the “demand side” 140 of the ad exchange system 100. The ADM module 108 and the GUI module 110 are each, independently, capable of enabling and controlling access and communication, by participants using user computing devices, with the ad exchange system 100 and, in particular, with the database 102 and sometimes with each other. The purpose and function of the ADM module 108 and GUI module 110 are slightly different, as will become evident in view of the following descriptions.

The ADM module 108 manages supply side information 132, at least in part by receiving, organizing, and storing that information 132 in the database 102. Supply side information 132 generally means the set of information which is organized, analyzed, collated, and reported, by the ADM module 108 and the GUI module 110, to advertising buyers, such as advertisers (A), on the “demand side” 140 of the ad exchange system 100. It is contemplated that advertisers (A) will be interested in accessing the ad exchange system 100 to identify suitable advertising inventory I available on packaging P1, P2, based on demand side information and preferences 142 such as, but not limited to, distributor (D) identity, consumer demographics, and other criteria of interest to advertisers (A) seeking to develop an advertising campaign, and especially a targeted advertising campaign. As shown in FIG. 1 and will be discussed in detail later, the GUI module 110 provides and executes an onboarding module 300 which initially allows advertising buyers, such as advertisers (A), to access the system 100 and provide such demand side information and preferences 142 to the GUI module 110.

Supply side information 132 received by the ADM module 106 typically, but not exclusively, comes or is derived from distributors (D), supply chain tracking information for shipped packaging P1, P2, triggers and other scanning and transmitting technologies associated with packaging P1, P2, as well as from delivery media providers. Distributors (D) provide various types of supply side information 132 including, without limitation, the identity and location of a distributor, the industries or markets served by the distributor, and the types and categories of consumer goods and services sold and or shipped to consumers. Of course it is possible for supply side information 132 to be provided by or otherwise derived from proprietor participants PP.

More particularly, the kinds of distributor (D) information which may be received and managed by the ADM module 108 of the ad exchange system 100 includes, for example without limitation, one or more of: industry(ies) of operation or interest, product category(ies) of operation or interest, locations of headquarters and any manufacturing, sales, and distribution facilities, market locations of operation or interest, affiliates, competitors, size (number of employees, annual or other periodic sales or income amounts, market share, publicly or privately owned, identity and location of suppliers and customers, and any other information which might assist in the evaluation or prediction of marketing and sales behavior, requirements, or interests, overlapping or complementary interests with other participants, and conflicts of interest or competition with other participants.

Delivery media information, which may be among the supply side information 132 received by the ADM module 108, is generally any information which relates to the options available for selection and design by distributors (D), advertisers (A), or both. Consequently, delivery media information typically includes, for example without limitation, one or more of: type, material, size and shape, features and characteristics, quantity, delivery date, location and size of remaining available advertising space(s) or area(s) for adding or combining with advertising content, optional triggers for interactive exchange of other information (e.g., consumer information, product information, advertiser information, etc.). Delivery media information may also be provided by or derived from delivery media providers.

Many types of delivery media exist and, therefore include, for example without limitation, product packaging or labeling, shipping or transportation packaging, internet websites and webpages, product and service brochures, instruction manuals and other literature, billboards, posters, and the like, and combinations thereof. Product packaging materials may include, for example without limitation, one or more of: paper, fiber, fabric, glass, ceramic, cardboard, and plastic. Packaging deliver media may also include, without limitation, one or more of: tape, adhesive, staples, cord, string, stitching, and other attachment or assembly materials or devices.

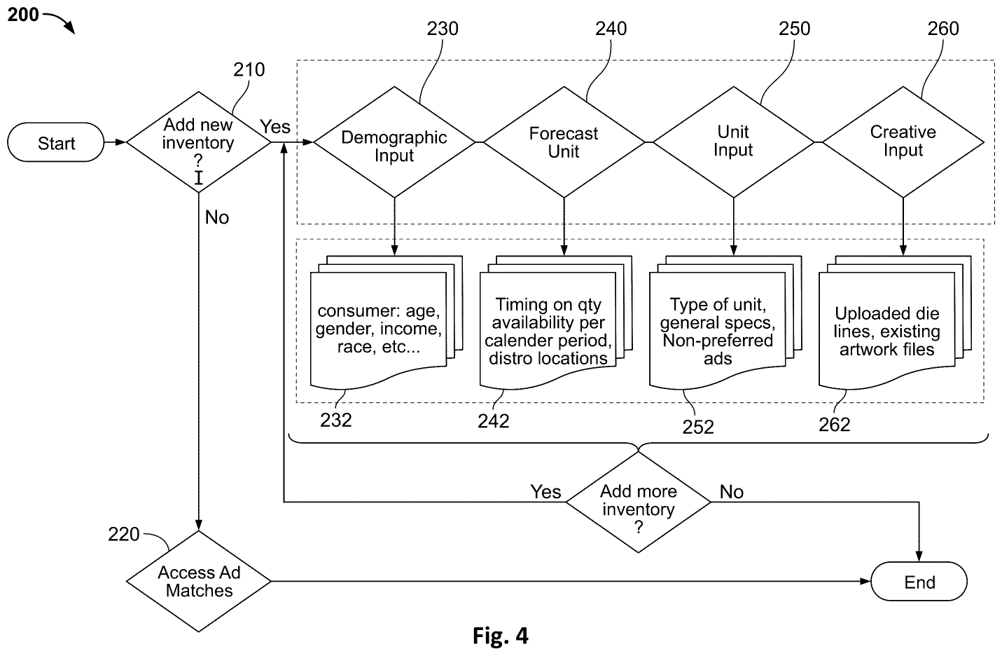

With reference to FIG. 4, distributors (D) and their packaging (e.g., through triggers thereon or conventional chain of custody that is tracked and collected during transport and delivery of packaging) provide much of the supply side information 132 that is received and managed by the ADM 108 to populate the database(s) 102, 102a, 102b, 102c, 102d with the kinds of information that is used by the ad exchange 100 to identify and define advertising inventory, based on parameters provided by participants such as advertisers (A) on the demand side of the exchange 100. Information regarding package shipping and delivery may include, for example, without limitation, the date(s) on which delivery media and the product or service associated therewith: (1) was packaged and shipped from the distributor (D), or printed and mailed for distribution or publishing, (2) was received by the consumer/addressee, and (3) was scanned or recorded at one or more intermediate locations along the route from distributor (D) to consumer, as well as those intermediate location(s).

More particularly, the ADM 108 includes and executes a supply side module 200 which controls access and input of information by distributors (D) and other participants (e.g., delivery media providers, proprietor participants (PP)) to the ad exchange system 100 and its databases 102, 102a, 102b, 102c, 102d. Initially, a distributor (D) or other participant may first elect 210 whether to add information relating to new advertising inventory I, or access and research whether the ad exchange system 100 has matched 220 any of their existing advertising inventory (I) with one or more advertisers (A) or other participants seeking advertising inventory space to purchase or lease for affixing their own advertising content. If a participant elects to access and research 220 previous or current inventory matches with one or more advertisers (A), the remaining functions of this supply side module 200 are bypassed. Accessing and researching 220 previous or current inventory matches also provides access to information concerning the performance and effectiveness of advertising content which was combined with advertising inventory I of one or more of that participant's delivery media (e.g., bags P1, P3 and boxes P2, P4).

If a participant elects to add 210 new inventory I and information related thereto, the supply side module 200 provides several portals 230, 240, 250, 260, each of which guides the distributor (D) through providing several kinds of information to the ad exchange system 100. A demographic input portal 230 is provided for providing demographic information and attributes 232 relating to consumers that are customers of the distributor (D). Such consumer demographic information and attributes 232 include, for example without limitation, one or more of: age, gender, ethnicity, residence location, marital status, education level, number and ages of any children, occupation, purchasing history, and shopping history.

Referring still to FIG. 4, the supply side module 200 also provides a packaging unit forecast portal 240 for the distributor (D) to provide information 242 relating to its forecasted use of its packaging units (e.g., delivery media). Such packaging forecast information 242 includes, for example without limitation, one or more of: types of packaging units shipped or to be shipped, quantities of packaging units shipped, assembled and addressed for shipping, and waiting to be assembled and addressed for shipping, timing or schedule(s) for shipping packaging units, periodic availability of packaging units having advertising inventory (e.g., quantity per week, month, year, etc.), distribution locations for packaging units, and any other information that may facilitate determination of whether packaging units and their use would be suitable and desirable for an advertiser (A) to purchase or lease advertising inventory thereon.

A packaging unit input portal 250 is also provided by the supply side module 200 for the distributor (D) to provide information 252 relating to characteristics and specifications of its packaging units (e.g., delivery media) and advertising inventory thereon, as well as the distributor's (D) preferences or limitations. The packaging unit characteristics and specifications information 252 typically includes, for example without limitation, one or more of: types and quantities of packaging units being purchased or already in use by the distributor; packaging unit size (dimensions), shape, volume, and material(s) of construction; characteristics and specifications of the advertising inventory space(s) on packaging units (e.g., number and dimensions of available unused space(s) on each packaging unit of a particular type and size); background color or color scheme of family of existing advertising content or other content or graphics on the packaging units; categories, characteristics, quantities, etc., of consumer goods and services being delivered with the packaging units.

Information regarding available or offered sizes and shapes of delivery media may include, without limitation, length, width, height, volume, two dimensional, three dimensional, box, bottle, vessel, carton, barrel, envelope, bag, pouch, tray, tank, sphere, an object such as a castle, a tree, an animal, a vehicle, number of pages for websites or printed materials, etc. Information regarding available or offered features and characteristics of delivery media may include, without limitation, one or more of solid, transparent, colors, monochrome, folded, molded, rigid, flexible, shiny, matted, metallic, textured, smooth, layered, insulated, nested or otherwise assembled components, having windows, tabs, slots, extensions, handles, etc.

Information regarding products or services means information concerning products and services being shipped or already otherwise associated with delivery media being prepared, printed, published, etc. Moreover, such information (“unit data” 114) may include, for example without limitation, the type and quantity of the products or services, the brand (if any) of the product or service, the source or manufacturer of the product or service, etc.

Information relating to a distributor's preferences or limitations 252 that is provided through the packaging unit input portal 250 includes, for example without limitation, one or more of: categories, types, and identities of advertisers (A) or other participants preferred or excluded by the distributor (D); categories and types of consumer goods and services preferred or excluded by the distributor (D); colors, symbols, graphics, and the like, which are preferred or excluded by the distributor (D).

Another portal provided by the supply side module 200, as shown in FIG. 4, is a creative input portal 260 which enables and guides a distributor (D) to provide information and specifications 262 for manufacturing the distributor's (D) packaging units include, for example without limitation, one or more of die lines for defining the shape and dimensions of the packaging units, electronically formatted instructions for creating (forming, printing, affixing, etc.) preexisting advertising content, artwork, graphics, logos, other informational content or graphics, etc. It is contemplated that delivery media providers may also provide options, templates, and recommendations for manufacturing information and specifications 262 for packaging units using the creative input portal 260. Delivery media providers may also do so using these or other modules and portals of the ad exchange system 100, as will be described later.

The ADM module 108 manages supply side information 132, at least in part by receiving, organizing, and storing that information in the database 102. Supply side information 132 generally means the set of information which available to advertisers (A) on the demand side who desire to identify suitable advertising inventory I on packaging P1, P2 (see FIG. 1) based on factors such as distributor (D) identity, consumer demographics, and other options available to advertisers (A) seeking to develop an advertising campaign, and especially a targeted advertising campaign.

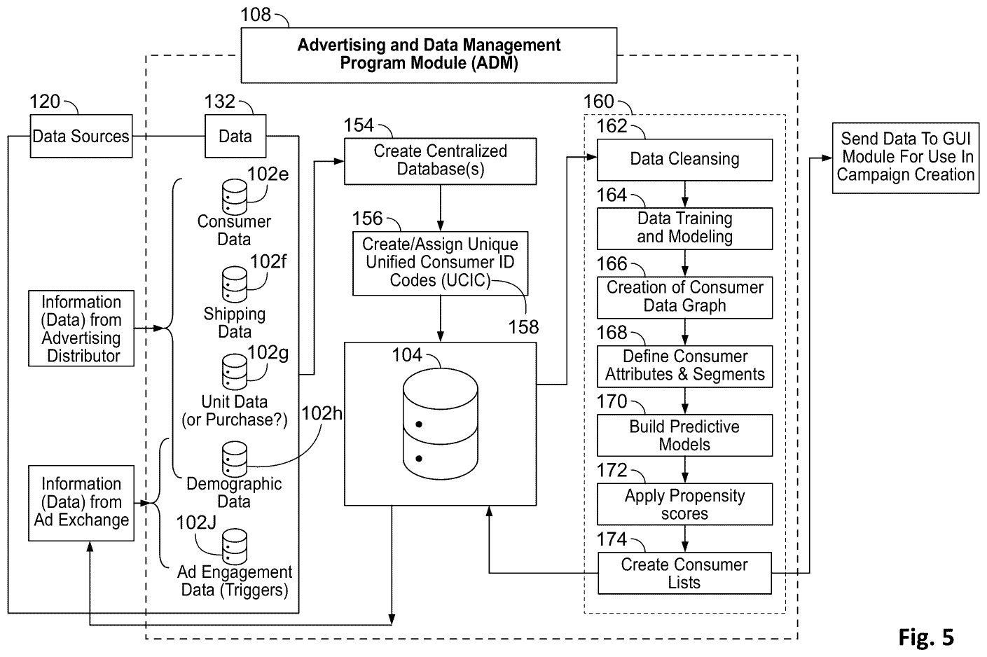

More particularly, FIG. 5 provides a schematic representation of the ADM module 108 of the ad exchange system 100, which receives supply side information 132 from one or more sources 120 including but not limited to distributors (D) and chain of custody tracking of their packaging units 122, as well as from the ad exchange system 100, such as via one or more triggers on packaging units selected and used in advertising campaigns by advertisers (A).

As also shown in FIG. 5, the supply side information 132 is organized, collated, and stored in one or more datasets or databases 102e, 102f, 102g, 102h, 102j of the ADM module 108. As has been discussed, the supply side information 132 relates to several aspects of the distributor's (D) packaging, consumers, products shipped in the packaging, advertising inventory available for purchase, and the like. The ADM module 108 performs additional operations including creating 154 one or more centralized ad exchange databases 104 for containing reorganized supply side information 132, and creating and assigning 156 a unique unified consumer identification code (UCIC) 158 to each consumer identified in the one or more datasets or databases 102e, 102f, 102g, 102h, 102j.

As also depicted in FIG. 5, the ADM module 108 uses the reorganized supply side information 132 in the centralized database(s) 104 to perform several data management and analysis functions 160, including but not limited to: cleansing the reorganized data 162, creating and training various models 164, graphing and mapping demographic and attribute information to consumers 166, categorizing and defining consumer attributes and segments across consumer populations 168, building and training predictive models 170, calculating and applying propensity scores 172. The ADM module 108 also communicates and cooperates with the GUI module 110 to create consumer lists 174 which are also stored on the centralized database(s) 104.

As will be readily understood by persons of ordinary skill in the relevant art, several of the foregoing data management and analysis functions 160 eliminate redundancy, noise and bad data from the supply side information 132 (e.g., cleansing 162) and reorganize the supply side information 132 (e.g., graphing and mapping 166 and categorizing and defining consumer attributes and segments 168) to render the information more easily searchable, analyzable, and reportable by and for participants. The function of categorizing and defining consumer attributes and segments 168, for example without limitation, may be performed by programming and algorithms based on or utilizing Boolean logic, statistical analysis, and other collating and analysis techniques. Reorganizing the information 132 facilitates other of the aforesaid functions 160 (e.g., creating and training models 164, building and training predictive models 170, and calculating and applying propensity scores 172). All of the data management and analysis functions 160 performed by the ADM module 108 are intended to enable and facilitate analysis and manipulation of the supply side information 132 by the GUI module 110 to identify, match, and recommend suitable advertising inventory according to preferences and requirements (e.g., demand side information 142) provided by participants, such as advertisers (A), from the “demand side” 140 of the ad exchange system 100.

The functions of creating, building and training models, including predictive models, 164, 170, as well as application of propensity scores 172, may use any one or more types of data analysis programming and algorithms including, without limitation, neural net learning, machine learning, and other forms of artificial learning, pattern recognition, artificial intelligence, associative and dependence assessments, and the like. Such programs and algorithms typically, but not exclusively, analyze and collate data, including large sets of data as are built and supplemented by the ad exchange system 100 and its various components and modules described herein, to identify and report statistical measurements and assessments, suspected, expected, and new patterns of consumer and participant behavior, preferences, similarities, divergencies, histories, and other characteristics and attributes.

For instance, one of, but not the only, useful report and feedback provided by such models, particularly but not only after training using supplemental and future information (data), will be the likelihood of interest by consumers (e.g., subsets or groups of consumers having one or more similar or overlapping demographic characteristics) in specific good and services. This will assist demand side participants, such as advertisers (A), as well as proprietor participants (PP), in researching and assessing which available advertising inventory I, 11, 12, 13, 21, 22, 23, on which delivery media units (e.g., bags P1, P3, and Boxes P2, P4), of which supply side participants, such as distributors (D), would be the most likely to provide or enhance success and profit derived from their advertising campaign.

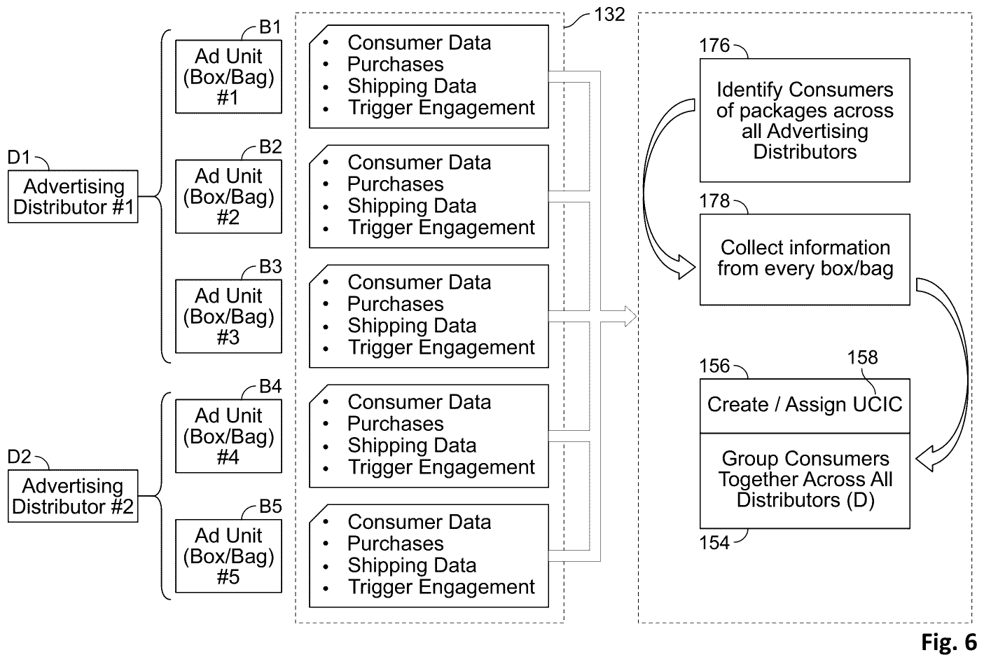

FIG. 6 is a schematic diagram which provides more detail concerning from where supply side information 132 (described in detail above in connection with FIG. 4) is received and how it is organized, collated, and stored (see description of data management and analysis functions 160 provided above in connection with FIG. 5) in one or more datasets or databases 102e, 102f, 102g, 102h, 102j of the ADM module 108. It is noted that the databases 102e, 102f, 102g, 102h, 102j shown in FIG. 5 may be the same, different, or overlap at least partially with the previously described databases 102a, 102b, 102c, 102d shown in FIG. 1, and information contained in all of them is received, analyzed, and reorganized into one or more central databases 104 (see FIG. 5) by the ADM module 108.

Furthermore, it is possible and contemplated that any of the above-described supply side information 132 to be provided to, or otherwise received by, the ADM module 108 of the ad exchange system 100 may already be organized or formatted in a database. Such database formatted information will be at least partially added to, integrated with, or both, one or more of the databases 102a, 102b, 102c, 102d, 102e, 102f, 102g, 102h, 102j of the ADM module 108.

Referring still to FIG. 6, each supply side participant, such first and second distributors (D1, D2) shown in FIG. 6, may have one or more types of delivery media, such as the bags and boxes B1, B2, B3 and B4, B5, respectively, for which they will provide supply side information 132 such as, but not limited to, characteristics, specifications, chain of custody tracking, and advertising inventory, to the ADM module 108 of the ad exchange system 100. As previously described in connection with FIG. 5 and depicted again in FIG. 6, after receiving supply side information 132, the ADM module 108 organizes, collates, and stores the information 132 in one or more datasets or databases 102e, 102f, 102g, 102h, 102j. Then the ADM module 108 performs several data management and analysis functions 160 using the supply side information 132 (e.g., creating and assigning 156 a UCIC 158 for each consumer, and creating 156 one or more centralized databases 104). Additional data management functions 160 performed by the ADM module 108 accomplishes other tasks including, without limitation, identifying consumers 176 for all packages (i.e., all bags and boxes B1-B5) across all distributor participants (D1, D2), and collecting information 178 provided from and about every package (i.e., each bag and box B1, B2, B3, B4, B5).

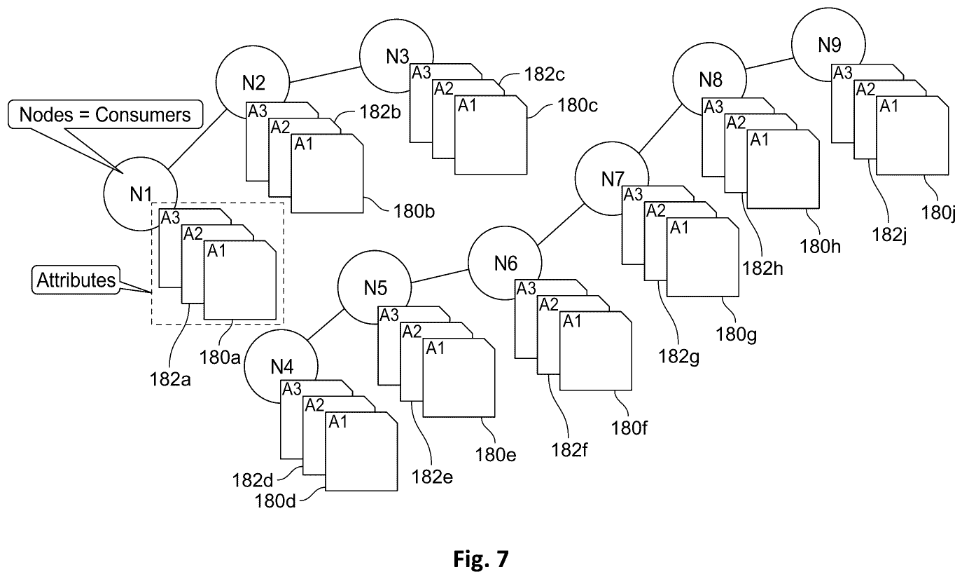

FIG. 7 is a schematic representation of how various types of information (attributes) relating to consumers are mapped or graphed by certain of the data management and analysis functions 160 of the ADM module 108. More particularly, consumer attribute information is graphed and mapped to consumers 166, so that reorganized supply side information 132 includes a plurality of consumers (N1 to N9), each of which has associated demographic information 180a, 180b, 180c, 180d, 180e, 180f, 180g, 180h, 180j and purchasing history (activity) 182a, 182b, 182c, 182d, 182e, 182f, 182g, 182h, 182j.

As previously mentioned, consumer attribute information is typically provided by, or otherwise received from, any of multiple possible sources including, without limitation, advertising distributors (D), delivery media (e.g., bags and boxes B1, B2, B3, B4, B5 such as shown in FIG. 6), and triggers 24, 25, 26 (see, e.g., FIG. 3) affixed to or otherwise associated with the delivery media received by consumers (N1 to N9). It should also be noted that the ad exchange system 100 allows for such demographic and purchasing history information to be supplemented and updated, on an ongoing basis, with additional supply side information 132 from distributors (D) and, sometimes, from one or more triggers 24, 25, 26 provided on packages (e.g., bag P3 and box P4, shown in FIG. 3) which are shipped and received by consumers. The graphing and mapping 166 of consumer attribute information 180, 182 to consumers (N1-N9) facilitates the data management and analysis function 160 of categorizing and defining of consumer attributes and segments across consumer populations 168 which is also performed by the ADM module 108.

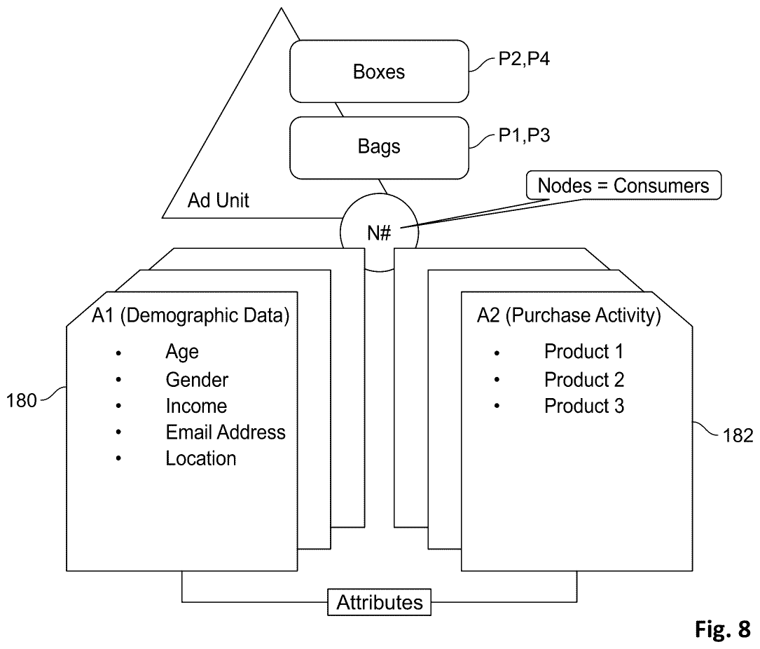

FIG. 8 is a more detailed schematic representation of a typical consumer (N #), i.e., such as one of those depicted in FIG. 7, as well as several non-exhaustive examples of types of consumer attribute information (demographic 180 and purchase history 182) that may be collected or received and associated with that customer. FIG. 8 also shows examples of the types of delivery media (e.g., boxes P1, P3 and bags P2, P4, etc., as shown in FIG. 1) which may be a source such consumer attribute information. The mapping and graphing of consumers and their demographic, shopping and purchasing information enables the use of deep learning methodologies by the ADM module 108 of the ad exchange system 100 as described above, which in turn provides participants with methods to explore and understand complex and dynamic relationships between consumers and purchase behavior. Such exploring and understanding of consumer purchase behavior facilitates the selection of suitable advertising inventory on delivery media (e.g., packaging) for the design of more successful targeted advertising campaigns.

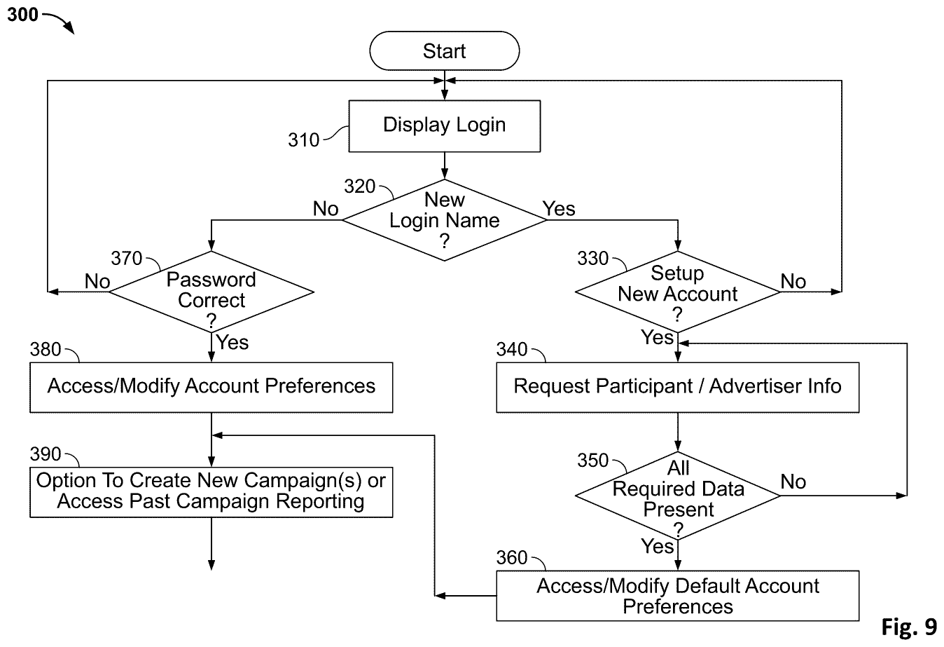

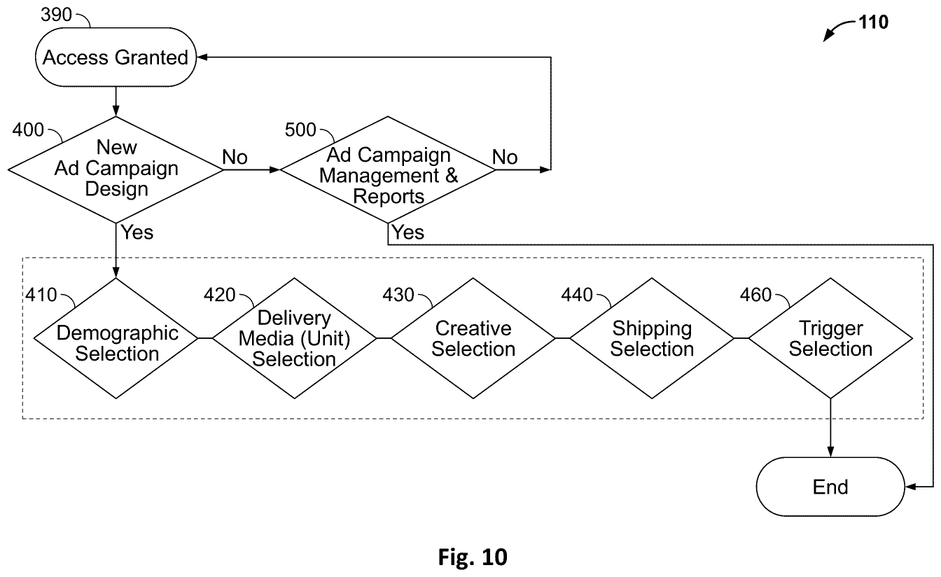

With reference briefly back to FIG. 1, the GUI module 110 generally manages demand side participants (A) (e.g., advertising buyers and brokers, and advertising brands themselves) and demand side information 142 which is generally, but not necessarily, provided by such demand side participants. Accordingly, as will be described below in further detail with reference to FIGS. 9-14, the GUI module 110 includes and is capable of managing several operations such as receiving, organizing, and communicating demand side information 142. Demand side information 142 typically includes, without limitation, one or more of: demand side participant information and demographics, elections, preferences, limitations, specifications, and instructions from such participants. The GUI module 110 communicates such demand side information 142 to, and receives reports and recommendations based thereon from, the centralized database(s) 104, the data management and analysis functions 160, and the advertising campaign design module 400 (see FIG. 10 which is discussed further hereinbelow). It is contemplated that, of course, proprietor participants (PP) may also engage with the GUI module 110 in any of the same ways and for any of the same or similar purposes, as well as in different ways and for different purposes, as described below for other participants, such as advertisers (A).

Referring now to FIG. 9, one of the tasks performed by the GUI 110 is providing and managing an onboarding process by executing an onboarding module 300 which controls access and exchange of information to and from the ad exchange system 100 and its central database(s) 104 by advertisers (A) and other demand side participants participants (e.g., delivery media providers). For example, an advertiser (A) may wish to identify advertising space (i.e., inventory) 24, 25, 26 on delivery media (e.g., such as bags P1, P3 and boxes P2, P4) which are being shipped by certain distributors (D), or which are expected to be shipped to consumers of a preferred market segment (i.e., consumers having demographic and attribute characteristics of interest to the advertiser (A)). Such an advertiser (A) may access and use the ad exchange system 100 to research and identify distributors (D) and delivery media which is likely to serve consumers of the preferred market segment.

Initially, the onboarding module 300 provided by the GUI module 110 displays a login page 310 on the screen of a user computing device (not shown), thereby inviting an advertiser (A) to login to an existing account or create a new account on the ad exchange system 100. More particularly, a participant operates their user computing device (not shown) and enters a login name or ID on the login page 310. The onboarding module 300 communicates and verifies 320 with the GUI module 110 whether the entered login name is new or associated with an existing account.

If the login name is new, then the advertiser (A) is presented with the option to create a new account 330 in the ad exchange system 100. When the advertiser (A) elects to create a new account 330, they are first prompted to select and enter an account password and then to provide 340 participant information to the GUI module 110.

For example, when the participant is an advertiser (A), the participant information which is provided 340 will be advertiser information including, for example without limitation, one or more of: industry(ies) of operation or interest, product category(ies) of operation or interest, locations of headquarters and any manufacturing, sales, and distribution facilities, market locations of operation or interest, size (e.g., number of employees, annual or other periodic sales or income amounts). Other possible relevant advertiser information provided 340 to the GUI module 110 via the onboarding module 300 includes market share, publicly or privately owned, affiliates, competitors, identity and location of suppliers and customers, and any other information relating to the advertiser (A) which might assist in the evaluation or prediction of marketing and sales behavior, requirements, or interests, overlapping or complementary interests with other participants, and conflicts of interest or competition with other participants. With this advertiser information 340, GUI module 110 communicates with the ADM module 108 and centralized database(s) 104 of the ad exchange system 100. The ADM and GUI modules 108, 110 work together to compare and link consumer purchase behavior and attributes to individual consumer profiles (e.g., using the graphed information relating to consumers shown in FIGS. 7 and 8) and, thereby, provides advertisers (A) with a path to navigate and research online and offline consumer information (data).

The onboarding module 300 analyzes the participant (advertiser (A)) information provided and verifies whether all required information has been provided 350. If all required information has not yet been provided to the onboarding module 300, the participant may either remain on or be returned to the prompt 340 until they have provided the missing required information.

After the onboarding module 300 confirms that all required participant information has been provided 350, the advertiser (A) or other new participant is offered the opportunity to review and modify 360 any default account preferences which are proposed by the onboarding module 300. Default account preferences, which may or may not be proposed and included in a new account by the GUI module 110, include, but are not limited to, time zone settings, privacy settings, account management, advertising preferences, audience (e.g., consumer segment) preferences, notifications, alerts, and the like.

With continued reference to the onboarding module 300 shown in FIG. 9, if the login name provided by a demand side participant is not new 320, the participant is able to provide a password, which is then verified 370 by the onboarding module 300, followed by allowing access 380 to the participant's existing account and information stored therein. At this point, the participant may review and modify previously set account preferences 380.

With reference to FIGS. 9 and 10, after account preferences have been reviewed, optionally modified, and accepted, the onboarding module 300 will grant access 390 to advertising campaign design and management modules 400, 500 of the GUI module 110 by the demand side participant. At this point, a demand side participant, such as an advertiser (A), advertiser broker, etc., may engage in researching, assessing, designing, and managing an advertising campaign, including a targeted advertising campaign, using the ad exchange 100, the information contained and managed therein, as well as several of the data management and analysis functions 160 and reporting tools.

FIG. 10 provides a schematic diagram of the GUI module 110 which includes an advertising campaign design module 400 and its several functional submodules, and an advertising campaign management module 500. The advertising campaign design module 400 enables a demand side participant, such as an advertiser (A), to design an advertising campaign based on parameters and criteria selected by the advertiser (A). Separate and independent of the advertising campaign design module 400, the advertising campaign management module 500 enables a demand side participant, such as an advertiser (A), to manage previous and ongoing advertising campaigns of that advertiser (A) by enabling research and analysis which produces any of several types of reports (factual, modeled, and predictive), based on parameters and criteria selected by the advertiser (A). Such reports enable monitoring the reach and effectiveness of advertising campaigns.

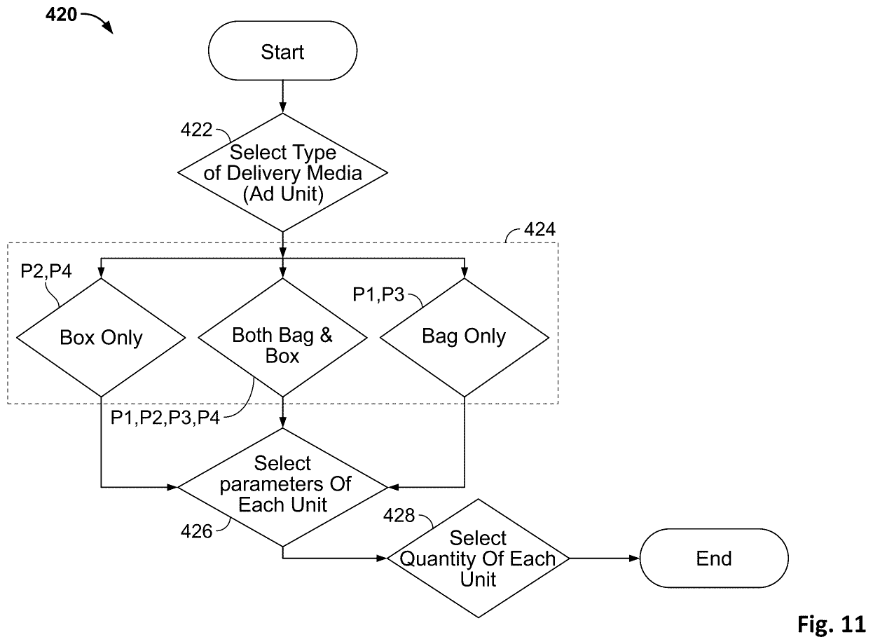

As will be discussed in further detail with reference to FIGS. 11-13, after entry to the ad exchange system 100 using the onboarding module 300, advertisers (A) are guided by several submodules 410, 420, 430, 440, 460 of the advertising campaign design module 400 through selecting and providing demand side information 142 which assist in developing one or more advertising campaigns. The advertising campaign design module 400 is particularly effective at designing targeted advertising campaigns aimed at the consumers of a selected preferred market segment.

The ad exchange system 100 employs the advertising campaign design module 400 and information provided thereto by demand side participants, such as advertisers (A), as well as the ADM module and the information provided thereto by supply side participants, such as distributors (D) or delivery media providers (e.g., packaging manufacturers and distributors), to compare and identify overlap of consumer demographics between demand side and supply side participants, as well as to identify and minimize conflict and association between participants based on their input (e.g., competitors, disfavored industries or brand names, etc.). Conflict and disfavored associations are assessed and determined based on input from participants, as well as programming, information and algorithms developed and provided by designers, owners and operators of the ad exchange system 100 (such as, without limitation, delivery media providers and proprietor participants (PP)).

The demand side information 142 provided by the advertiser (A), or other demand side participant, includes preferences and parameters of the advertiser (A) and relate, for example without limitation, to one or more of: targeted consumers and their demographic and other attribute characteristics and information 410, types of delivery media (units) 420, advertising creative content and artwork 430, shipping parameters (dates, destinations, etc.) 440, and trigger types and content 460. It is not necessary to access and execute all of the submodules 410, 420, 430, 440, 460, for each to be effectively utilized. Additionally, it is contemplated that, generally, one or more of the submodules 410, 420, 430, 440, 460 may be accessed and executed in any order relative to one another and still be effective.

FIG. 11 provides a schematic representation of the delivery media (unit) selection submodule 420 of the advertising campaign design module 400 shown in FIG. 10. The delivery media selection submodule 420 allows and manages the selection 422 of parameters and characteristics for the delivery media (unit). First, as advertiser (A) may specify what type of delivery media they prefer or require. For example, an advertiser may be interesting in packaging 424 for shipping products, and may then specify whether they seek advertising inventory on bags P1, P3, or boxes P2, P4, or both P1, P2, P3, P4 (see FIGS. 2 and 3).

More generally, delivery media information includes, but is not limited to, type, material, size and shape, features and characteristics, quantity, delivery date, location and size of remaining available advertising space(s) or area(s) for adding or combining with advertising content, optional triggers for interactive exchange of other information (e.g., consumer information, product information, advertiser information, etc.). Types of delivery media may include, without limitation, product packaging or labeling, shipping or transportation packaging, internet websites and webpages, product and service brochures, instruction manuals and other literature, billboards, posters, and the like, and combinations thereof. Materials for delivery media may include, for example without limitation, one or more of paper, fiber, fabric, glass, ceramic, cardboard, and plastic, and may also include tape, adhesive, staples, cord, string, stitching, and other attachment or assembly materials or devices.

The advertiser (A) may also specify to the delivery media selection submodule 420 any required or desired specifications for advertising inventory 11, 12, 13, 21, 22, 23 (see FIGS. 2 and 3) suitable for combination with the advertising content and art of the advertiser (A). The delivery media selection submodule 420 may also communicate with the ADM module 108 to determine whether any qualifying packaging units exist which include advertising inventory having the aforesaid required or desired specifications provided by the advertiser (A).

For each particular type of packaging P1, P2, P3, P4 selected, the delivery media selection submodule 420 enables the advertiser (A) to provide 426 additional specifications and parameters such as, but not limited to, material, dimensions, other features (openings, flaps, lids, tabs or other affixing devices, etc.), background colors, and unwanted features (e.g., no larger than a specified volume, no plastics, etc.). The delivery media selection submodule 420 also enables the advertiser (A) to specify the quantity 428 of each type of packaging having the same additional specifications and parameters.

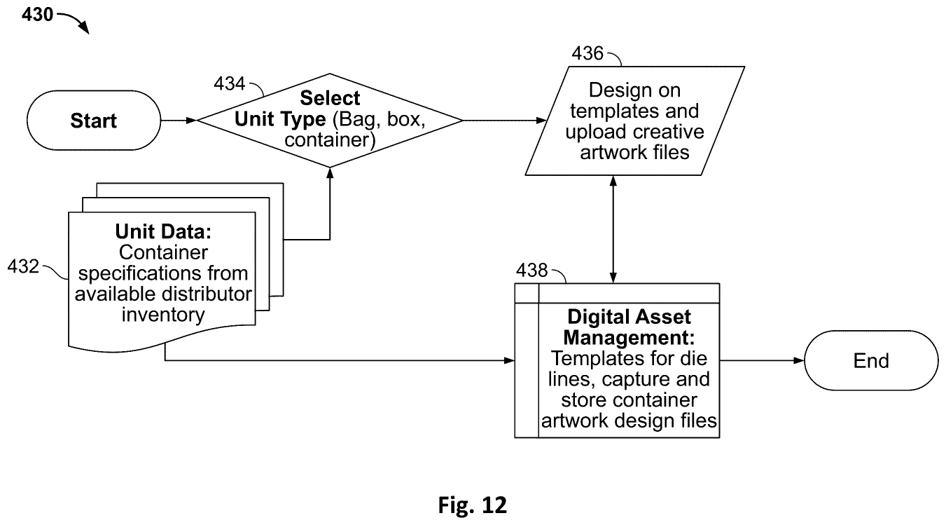

FIG. 12 provides a schematic representation of the creative selection submodule 430 of the advertising campaign design module 300 shown in FIG. 10. The creative selection submodule 430 receives 432 the parameters and specifications collected by the delivery media selection submodule 420 for the delivery media (packaging P1, P2, P3, P4) and advertising inventory 11, 12, 13, 21, 22, 23. When the advertiser (A) selects 434 the type of packaging for which they wish to design advertising content and creative art, the creative selection submodule 430 provides the possible options, templates, artwork and graphics applicable to the selected type of packaging and suitable advertising inventory, based on the parameters and specification associated therewith from the delivery media selection submodule 420.

The creative selection submodule 430 allows the advertiser (A) to select and optionally customize 436 one or more of the content options, templates, artwork and graphics. The creative selection submodule 430 includes or is otherwise in communication with a digital asset management (DAM) component 438. The DAM component 438 receives all of the information and selections received and collected from the advertiser (A) by the delivery media selection submodule 420 and creative selection submodule 430 and designs and produces 438 content files, executable code files, templates for manufacturing machine die instructions, and any other files and collections of information required to enable delivery media providers to manufacture packaging in accordance with the requirements and preferences provided by distributors (D) and the advertiser (A).

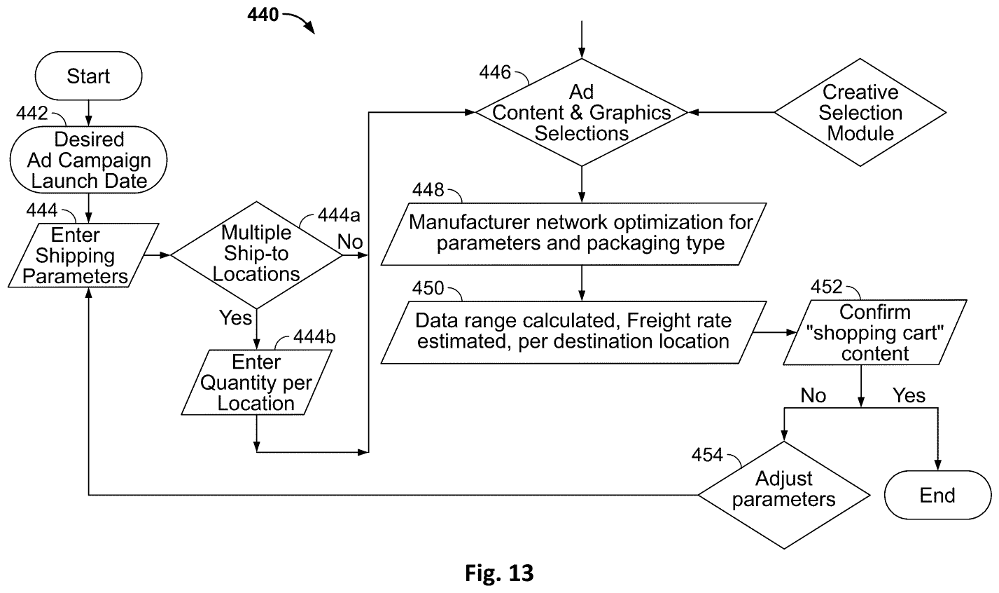

FIG. 13 provides a schematic representation of the shipping selection submodule 440 of the advertising campaign design module 400 shown in FIG. 10, which allows and manages the selection of several parameters by an advertiser for shipping the delivery media (units) having targeted advertising content thereon or otherwise associated therewith, and which integrates the selections and technical specifications from the creative from the creative selection function of FIG. 12. More specifically, the shipping selection submodule 440 enables the advertiser (A) to specify 442 a desired launch date for the advertising campaign being designed. The advertiser (A) is also able to provide 444 several shipping parameters including multiple shipping locations 444a, if applicable, and the quantity of packaging units 444b that the advertiser (A) wishes to be delivered to each location.

Through interaction and engagement with the shipping selection submodule 440 of the advertising campaign design module 400, an advertiser (A) has the opportunity to access, view, download, modify, customize, and eventually upload their own creative files containing one or more of their advertising content, art, and graphics. As described below, these files are then provided to and applied by packaging (delivery media) designers and manufacturers to produce the desired packaging which now includes the advertiser's (A) advertising content, art and graphics and will be shipped to the desired consumer segment.

As also shown in FIG. 13, the shipping selection submodule 440 also coordinates the manufacture of the packaging having the designed advertising content and art according to the preferences and specifications of the distributors (D) and advertiser (A) by receiving 446 and communicating to delivery media providers (e.g., packaging manufacturers and distributors) 448 all of the content files, executable code files, templates for manufacturing machine die instructions, and any other required files and collections of information that was designed and produced by the DAM 438 in cooperation with the creative selection submodule 430. Delivery media providers (not shown) review the aforesaid content files, executable code files, manufacturing templates, etc., to develop and communicate manufacturing and delivery time back to the shipping selection submodule 440, based upon which the shipping selection submodule 440 calculates campaign information 450 including, but not limited to, delivery date ranges and freight rate estimates for each type of packaging and each shipping location selected by the advertiser (A).

The advertiser (A) may then review and consider the calculated campaign information 450 provided by the shipping selection submodule 440 and either accept or decline 452 the advertising campaign and the parameters selected and designed thus far. If the advertiser (A) declines the advertising campaign designed thus far, the shipping selection submodule 440 allows the advertiser (A) to adjust or modify 454 one or more selections, parameters, and specifications of the advertising campaign and delivery media (packaging) by sending the advertiser (A) back to the selection of shipping parameters 444 step.

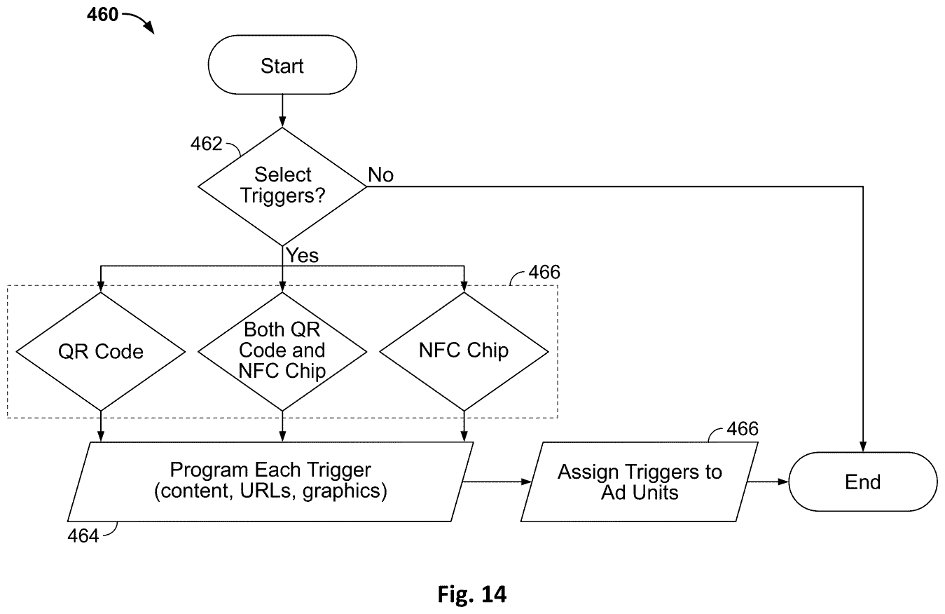

If the advertiser (A) accepts the advertising campaign designed thus far, the shipping selection submodule 440 next enables the advertiser (A) to access the trigger selection submodule 460 shown schematically in FIG. 14. The trigger selection submodule 460 enables the advertiser (A) to select the type 462 and design the content 464 of one or more triggers 466 to be attached, affixed, printed or otherwise included with the designed packaging units and advertising content. As has been described previously, each trigger is capable of collecting and transmitting information relating to consumers, products, and delivery media back to the ad exchange system 100, and particularly to the ADM module 108. After the advertiser (A) selects what type of trigger(s) and designs the content of each, the trigger selection submodule 460 assigns the trigger(s) to the delivery media (packaging units). The trigger selection submodule 460 provides the trigger type, content and assignment information back to the creative selection submodule 430 for integration into the packaging and advertising content design parameters and specifications, which are then provided to the shipping selection submodule 440. The parameters, specifications, and other information required for manufacturing the packaging having the advertising content and triggers in accordance with the selections and specifications provided by distributors (D) and the advertiser (A) are redesigned and recalculated by the shipping selection submodule 440.

Available triggers for inclusion on packaging to facilitate and encourage interactive exchange of information to and from consumers which receive or are otherwise in contact with or exposed to delivery media, include without limitation, any codes, transmission or other technologies which can be programmed or designed to transmit or communicate consumer information (e.g., demographics or other attributes). Optionally, triggers may also contain and provide a URL or website address which may provide further product or service information, or even an interactive experience, video entertainment, rewards program, referrals, sweepstakes, etc, to consumers or others who come in contact with the delivery media having a trigger thereon. The type of trigger is not particularly limited, as long as it can be affixed or otherwise associated and transported with delivery media. Types of triggers include, for example without limitation, quick response (QR) codes, barcodes, universal product codes (UPCs), digital coupons, near field communication (NFC) tags, radio frequency identification (RFID) devices, custom branded vanity uniform resource locators (URLs), email addresses, push notifications, non-fungible tokens (NFTs), and augmented reality.

Any trigger may be programmed or designed to include or provide any one or more of many different types of information, interactions, and experiences. Furthermore, it is contemplated that triggers may be variable triggers which means the triggers are programmed or designed to be individually uniquely identifiable so that, for example without limitation, each uniquely identifiable trigger would be affixed to a separate unit of delivery media. This renders each unit, such as each bag P1, P3, each box P.2, P4, or each bottle (not shown) or each of whatever type of physical delivery media is being used, a separate and uniquely identifiable packaging item. This further personalizes and individualizes the delivery media, as well as the packaging and consumer information collected and fed back to the ad exchange system 100 by each trigger.

The above-described ad exchange system 100, and its various possible modified and alternative embodiments enables one or more participants to perform many methods for offering, managing, researching, selling, buying, designing, and understanding advertising inventory on delivery media (including digital or virtual media, physical media, or both) and the creation of advertising campaigns, including targeted advertising campaigns, using information provided, accumulated and managed using several sophisticated and complex data management techniques and programmed modules and functions. Such methods include, but are in no way limited to one or more of the following:

### Supply Chain (Supply Side) Aspects

A. Enabling and performing integrated packaging tracking: visual process from pricing >art>marketing integration>manufacturing>logistics>analytics
B. Integrating and employing 3D/augmented reality sample modeling for quicker customer packaging approvals
C. API into manufacturing partners and customers
D. Tie or link ordering platform online into ERP
E. Linking directly to distribution centers for programmatic advertisement

### Marketing (Demand Side) Aspects

A. Providing options for ad exchange system to host advertising content such as videos, augmented reality (AR), and variable coupons for participant advertisers
B. Integrating and providing platforms such as digital asset management (DAM), customer relationship (CRM) for smart data delivery to participants
C. Providing marketing integrations which calculate or recognize and capture social scores (e.g., using AR, computer generated imagery (CGI), Text2buy, discounts, virtual #tags, etc.)
D. Instant web scraping for social and/or influencer key performance indicators (KPIs)
E. Creating and providing metatags on or otherwise associated with advertising campaigns to track trends, and integrate AI

### Ad Exchange Aspects

A. Providing and managing a marketing portal for consumer brands (i.e., advertisers) to pay for advertisements (placement of advertising content and graphics) on open distribution advertising inventory on packaging which will be available globally
B. Automatically connecting brands via demographics, regions, and campaigns
C. Providing and managing a “buy now” as well as a bidding system for advertising inventory to create and build demand during peak seasons
D. Directly connecting die lines (e.g., manufacturing specifications for physical delivery media) and 3D modeling, thereby facilitating ease of use for agencies/smaller brands/individuals (advertisers of medium to small size or volume) to work off platform
E. Controlling transfer of assets for quality assurance (QA) and printer manufacturing
F. Optimizing selection of packaging manufacturing partner(s) based on advertising inventory order volume, physical region/location, and manufacturing equipment and capabilities required to produce desired packaging, advertising content and graphics, as compared to manufacturer capabilities and capacity.

The exchange systems and methods described above and contemplated herein will enable participants such as distributors (e.g., retailers, wholesalers, branded entities, etc.) to include their own advertising content on their own delivery media (e.g., packaging, websites, brochures, etc.), or to include advertising content of others on their delivery media which may partially or entirely offset the cost of that delivery media. Additionally, such participants are also enabled to include their advertising content on the delivery media of others which may reduce the overall cost of producing and distributing their advertising content to targeted consumers or a preferred market segment. Such participants would also be able to include their advertising content on delivery media produced, owned, and sold by a delivery media provider who would be responsible for identifying and partnering with one or more distributors for the use and distribution of such provider owned delivery media, which would reduce the effort and cost for such participants of identifying and using suitable delivery media for producing and distributing their advertising content to targeted consumers or a preferred market segment. Any of the foregoing situations and participant partnerships could easily be a component of a targeted advertising campaign designed, implemented and managed in accordance with the exchange systems and methods described and contemplated herein.

In practice, it is contemplated and expected that participants such as distributors, including for example without limitation, wholesale sellers, wholesale shippers, retail sellers, retail shippers (collectively “merchants”), would have the expense of the delivery media they use subsidized or even eliminated while simultaneously providing their customers with an improved and enhanced shopping or shipping experience through exposure to additional targeted advertising for products and services likely to be of interest to them based on customer demographics such as, but not limited to, geographic location, income level, age, etc.

It is further contemplated that targeted advertising campaigns, arrangements, or participant partnerships developed and managed in accordance with the advertising exchange systems and method described and contemplated above, could be based on or conducted under the terms of a licensing, subscription, or membership agreement with monthly fees, or volume-based fees paid to the delivery media providers or other involved participants. Information and data produced from such arrangements, campaigns and partnerships would be collected, analyzed and managed for forecasting delivery media replenishment (e.g., in the case of physical delivery media having the advertising content thereon or associated therewith), as well as developing and reporting trends, insights, and predictions relating to other categories of consumer shopping and purchase habits buying.

Additionally, targeted advertising campaigns, arrangements, or participant partnerships which are developed and managed in accordance with the advertising exchange systems and method described and contemplated above may be of benefit to advertisers and advertising brokers seeking guaranteed and effective distribution to and interaction with consumers of preferred and targeted market segments, by providing one to one advertising capabilities and real time tracking and assessment of the effectiveness of targeted advertising campaigns.

The targeted advertising campaigns created, implemented, and managed using the advertising exchange systems and methods described and contemplated herein may also be structured to provide consumers with information which facilitates and enhances the shopping and purchasing experience for preferred and premium products, services, and events. Partnerships with consumers desiring such enhanced shopping and purchasing experiences may be based on a program of reward points earned for scanning, activating, or otherwise interacting with one or more triggers on or associated with delivery media received or possessed by the consumer. Such consumer reward programs would incentivize consumers to scan, activate, or otherwise interact with triggers which collect and provide consumer demographic information and other supply side information to the exchange system where it is available for analysis and research by delivery media providers, advertisers, and other participants.

We claim:

1. An integrated advertising exchange platform which provides effective designing, managing, monitoring, and assessment of effectiveness of advertising content, a targeted advertising campaign which includes advertising content, or both, wherein the advertising content is affixed to or associated with available advertising inventory which is on or associated with delivery media, the exchange platform being capable of identifying, selecting, and reporting suitable advertising inventory from among the available advertising inventory based at least in part on one or more demand side requirements, preferences, and limitations,
the exchange platform comprising a client software application (CSA) which includes a supply side module and a demand side module, each of which are accessible by one or more participants using one or more computing devices,
the supply side module manages supply side information and includes:
an advertising and data management (ADM) module which includes:
a data management submodule for receiving, organizing, and collating supply side information,
a database submodule comprising one or more databases for receiving and storing organized and collated supply side information,
one or more analysis submodules for further organizing, analyzing, collating, and reporting the supply side information stored in the one or more databases, including at least creating and assigning a unique unified consumer identification code (UCIC) to each consumer for which consumer information is received, and creating one or more centralized databases each of which contains at least a portion of the supply side information,
the demand side module including:
a graphical user interface (GUI) module which is programmed to be capable of:
receiving and managing demand side information which includes the one or more demand side requirements, preferences, and limitations,
providing and managing an onboarding process by executing an onboarding module which controls access and exchange of information by demand side participants to and from the exchange platform system and the one or more central databases,
selecting and reporting suitable advertising inventory from the available advertising inventory by analyzing and collating at least a portion of the supply side information with at least a portion of the demand side information,
designing, or enabling a demand side participant to design, advertising content, targeted advertising campaigns, or both, by executing an advertising campaign design module, wherein advertising content is affixed to or associated with suitable advertising inventory of the delivery media, receiving, producing, and managing advertising content information which includes characteristics and attributes of the advertising content, and targeted advertising campaign information which includes characteristics and attributes of the targeted advertising campaign, and
providing, designing, or enabling a participant to design, one or more triggers which are affixed to or associated with the delivery media and collect and transmit supply side information to the ADM module of the supply side module.

2. The exchange platform of claim 1, wherein the delivery media comprises physical delivery media, virtual delivery media, and combinations thereof.

3. The exchange platform of claim 2, wherein the physical delivery media comprises one or more of: packaging, product and service brochures, instruction manuals and other literature, billboards, posters, magazines, books, pamphlets, flyers, and any other tangible media which delivers, describes, provides, or communicates, consumer goods and services and their features, use, and operation to consumers.

4. The exchange platform of claim 1, wherein each participant is at least one type of person or entity selected from: advertisers, distributors, delivery media providers, and proprietor participants.

5. The exchange platform of claim 4, wherein a participant is two or more types of persons or entities selected from: distributors, advertisers, advertising buyers, advertising brokers, delivery media providers, and proprietor participants.

6. The exchange platform of claim 1, wherein the supply side information includes one or more types of information selected from: available advertising inventory information, delivery media information, supply side participant information, consumer demographic information, consumer product information, consumer service information, supply side participant industry information; and wherein the demand side information includes one or more types of information selected from: demand side requirements, preferences, and limitations, demand side participant information, demand side participant industry information, preferred consumer information, and preferred market segment information.

7. The exchange platform of 1, wherein the one or more demand side requirements, preferences, and limitations comprise information selected from one or more of the following types of information: supply side participant information, demand side participant information, consumer demographic information, preferred market segment information, available advertising inventory information, delivery media information, consumer product information, and consumer service information.

8. The exchange platform of claim 1, wherein each of the one or more triggers includes: a quick response (QR) code, a barcode, universal product code (UPC), a digital coupon, a near field communication (NFC) tag, a radio frequency identification (RFID) device, a custom branded vanity uniform resource locators (URL), an email addresses, a push notifications, a non-fungible tokens (NFT), augmented reality, or combinations thereof.

9. The exchange platform of claim 1, wherein supply side information collected and transmitted by one or more triggers to the ADM module of the supply side module of the CSA relates to a consumer and comprises one or more of: demographic information, product and service purchase history information, brand purchase history information, vehicle information, health status information, and medical history information.

10. The exchange platform of claim 9, wherein the consumer demographic information includes one or more consumer attributes selected from: name, gender, age, marital status, family members, geographic location or region, residential address, occupation, income, level of education, hobbies and interests, political affiliation, religion, and income.

11. The exchange platform of claim 1, wherein at least one of the one or more triggers also delivers or provides additional information, interaction, or other experiences to consumers who receive or are otherwise in contact with delivery media having advertising content thereon or associated therewith and included in a targeted advertising campaign.

12. The exchange platform of claim 1, where supply side information is received from one or more sources selected from: one or more supply side participants, one or more triggers provided on or associated with delivery media, and one or more databases external to the exchange platform.

13. The exchange platform of claim 12, wherein the supply side participants comprise at least one or more participants selected from: distributors, and delivery media providers.

14. The exchange platform of claim 1, wherein the demand side information comprises at least one or more types of information selected from: requirements, preferences and limitations concerning characteristics of suitable advertising inventory, preferred delivery media, preferred customer demographics, preferred market segment information, and instructions from a demand side participant.

15. The exchange platform of claim 1, wherein the demand side participants comprise one or more of advertisers, advertising buyers, and advertising brokers.

16. The exchange platform of claim 1, wherein when supply side information has been further organized, analyzed, collated, and reported by the one or more analysis submodules of the ADM, research and analysis to determine whether suitable advertising inventory is available for a demand side participant's advertising content, as well as which supply side distributors and their media are likely to reach or contact desired or preferred market segments and consumer populations for targeted advertising campaigns.

17. The exchange platform of claim 1, wherein the GUI is further programmed to be capable of producing, or enabling a participant to produce, based on parameters selected by the participant, one or more reports which include at least a porting of the targeted advertising information.

18. The exchange platform of claim 1, wherein the GUI communicates demand side information to and receives reports and recommendations from the one or more centralized databases of the ADM module, at least one of the one or more analysis submodules of the ADM module, and the advertising campaign design module of the GUI module, based on at least a portion of the demand side information.

19. A method for monetizing physical packaging using the integrated advertising exchange platform of claim 1, wherein the delivery media comprises one or more physical delivery media selected from: packaging, product and service brochures, instruction manuals and other literature, billboards, posters, magazines, books, pamphlets, flyers, and any other tangible media which delivers, describes, provides, or communicates, consumer goods and services and their features, use, and operation to consumers.

20. The method of claim 19, wherein the packaging comprises one or more containers, boxes, bottles, vessels, cartons, barrels, envelopes, bags, pouches, trays, each of which is made of flexible material, rigid material, or combinations thereof.

21. A method for designing, managing and monitoring targeted advertising campaigns, including using delivery media having available advertising inventory and affixing or associating advertising content to or with, respectively, suitable advertising inventory which is identified and selected based matching supply side information relating to the available advertising inventory with demand side requirements, preferences, and limitations relating at least in part to preferred consumer demographic information, the method comprising the steps of:
managing supply side information by receiving, organizing, and collating the supply side information, wherein the supply side information includes one or more of: consumer demographic information, consumer product information, consumer service information, and supply side participant industry information, and wherein the supply side information is received from one or more sources which include one or more supply side participants, one or more triggers affixed to or associated with delivery media having available advertising inventory and used in the targeted advertising campaign, one or more information analysis methods, and one or more third party databases;
storing the organized and collated supply side information in one or more databases;
further organizing, analyzing, collating, and reporting the supply side information stored in the one or more databases, which includes creating and assigning a unique unified consumer identification code (UCIC) to each consumer for which consumer information is received, and creating one or more centralized databases each of which contains at least a portion of the supply side information, including the unique UCIC codes assigned to each consumer;
managing demand side information by receiving, organizing, and collating the demand side information, wherein the demand side information includes one or more of: one or more demand side requirements, preferences, and limitations, demand side participant information, demand side participant industry information, preferred consumer information, and preferred market segment information, and wherein the demand side information is received from one or more sources which include one or more demand side participants, and one or more information analysis methods;
identifying, selecting, and reporting suitable advertising inventory from the available advertising inventory by analyzing and collating at least a portion of the supply side information with at least a portion of the demand side information which comprises one or more demand side requirements, preferences, and limitations;
designing, or enabling a demand side participant to design, advertising content, targeted advertising campaigns, or both, by executing an advertising campaign design module, wherein advertising content is affixed to or associated with suitable advertising inventory of the delivery media,
receiving, producing, and managing advertising content information which includes characteristics and attributes of the advertising content, and targeted advertising campaign information which includes characteristics and attributes of the targeted advertising campaign, and
providing, designing, or enabling a participant to design, the one or more triggers which are affixed to or associated with the delivery media, wherein each trigger is capable of collecting and providing supply side information.

22. The method of claim 21, wherein the one or more demand side requirements, preferences, and limitations comprise information selected from one or more of the following types of information: supply side participant information, demand side participant information, consumer demographic information, preferred market segment information, available advertising inventory information, delivery media information, consumer product information, and consumer service information.

23. The method of claim 21, wherein the supply side participants comprise at least one or more participants selected from: distributors, delivery media providers, and proprietor participants.

24. The method of claim 21, wherein the demand side participants comprise one or more of advertisers, advertising buyers, advertising brokers, and proprietor participants.

25. The method of claim 21, wherein suitable advertising inventory is identified and reported based at least in part, on one or more of consumer demographic information, the characteristics of one or more of the supply side participants, the characteristics of one or more of demand side participants, consumers, products and services, which are assessed concurrently by the platform.

26. The method of claim 21, further comprising the step of performing and managing an onboarding process for controlling access and exchange of information by demand side participants to and from the exchange platform system and the one or more central databases.
